(19) United States
(12) Patent Application Publication
(10) Pub. No.: US 2012/0216639 A1
(43) Pub. Date: Aug. 30, 2012

(54) SHIFTING DEVICE AND METHOD FOR SHIFTING CONTROL OF AN AUTOMATED GROUP TRANSMISSION

(75) Inventor: Stefan Renner, Bodman-Ludwigshafen (DE)

(73) Assignee: ZF Friedrichshafen AG, Friedrichshafen (DE)

(21) Appl. No.: 13/504,632

(22) PCT Filed: Oct. 13, 2010
(86) PCT No.: PCT/EP2010/065305

§ 371 Date: Apr. 27, 2012

(30) Foreign Application Priority Data
Nov. 11, 2009 (DE) 102009046620.7

(51) Int. Cl. F16H 3/08

(52) U.S. Cl. 74/331

(57) ABSTRACT

A shifting device and a method controlling shifting of transmission comprising main gearing and a splitter group which have a common countershaft. The splitter group is a double clutch transmission having two coaxially disposed input shafts, each of which can be connected, on the input side, to a motor drive shaft and, on the output side via a shiftable input stage, to the countershaft. Each input shaft of the shifting device is allocated a shift rail. Each shift rail is axially parallel and axially displaceable and is adjustably connected to the selector sleeve of an allocated shifting group via a shift fork and has engagement openings. A selector shaft is axially parallel to the shift rails and comprises selector fingers which engaging in the engagement openings of the shift rails. The selector shaft rotates, via a selection actuator, and is axially displaced, via a shifting actuator.

This application is a National Stage completion of PCT/EP2010/065305 filed Oct. 13, 2010, which claims priority from German patent application serial no. 10 2009 046 620.7 filed Nov. 11, 2009.

### FIELD OF THE INVENTION

The invention relates to a shifting device of an automated group transmission comprising a main gearing and a splitter group upstream thereof having at least one common countershaft, the splitter group thereof being in the form of a double clutch transmission having two coaxially disposed input shafts, each of which can be connected on the input side, via an allocated friction clutch, to the drive shaft of a drive motor and on the output side, via at least one shiftable input stage, to the countershaft. Moreover, the invention relates to a method for the shifting control of an automated group transmission of this type, in which a change of the load-transmitting input stage always takes place as a power shift within the splitter group.

### BACKGROUND OF THE INVENTION

Multi-stage manual transmissions typically have a countershaft design and therefore comprise a plurality of gearwheel sets disposed between two axially parallel transmission shafts, each having one fixed gear that is mounted in a rotationally fixed manner on the one transmission shaft, and an idler gear that is rotatably mounted on the other transmission shaft and is connectable thereto via an allocated gear clutch. The idler gears of axially adjacent gearwheel sets are mounted, usually in pairs, on a common transmission shaft, and so the allocated gear clutches are combined in pairs, in each case, in a common shifting group having a single selector sleeve.

For shifting, which is to say, to engage a certain gear step, the particular selector sleeve must be displaced axially from the central neutral position thereof in the direction of the idler gear of the applicable gearwheel set into the particular shift position and, to disengage this gear step, it must be displaced axially back into the neutral position. To this end, one shift rail can be provided for each shifting group, which is disposed axially parallel to the transmission shafts, is axially displaceable, is equipped with a shift fork that is engaged with the allocated selector sleeve, and comprises an engagement opening for engagement by a selector finger of a selector shaft. The selector shaft serves to initiate and transfer selection and shifting motions within the transmission, wherein, in a selection procedure, a form locking adjustment connection is established between the selector shaft and one of the shift rails and, in a shift procedure, a gear step of the applicable shifting group is engaged or disengaged via appropriate axial displacement of the coupled shift rail.

If the selector shaft is disposed axially parallel to the transmission shafts and the shift rails, a selection procedure involves rotating the selector shaft about the longitudinal axis thereof, and a shifting procedure involves axial displacement of the selector shaft. However, if the selector shaft is disposed tangentially-normally to the transmission shafts and the shift rails, a selection procedure involves axial displacement of the selector shaft, and a shifting procedure involves rotating the selector shaft about the longitudinal axis thereof.

In simple manual transmissions, in a selection procedure based on an H-shift pattern or a multiple-H-shift pattern, the adjustment connection between the selector shaft and a shift rail is always disengaged and engaged in the neutral position thereof, which is to say, with the gear steps disengaged. In a double clutch transmission comprising two coaxially disposed input shafts, each of which can be connected on the input side, via an allocated friction clutch, to the drive shaft of a drive motor and on the output side, via one group of shiftable gearwheel sets, to the output shaft, it must be possible, however, when a single selector shaft is used, to disengage and re-engage the adjustment connection between the selector shaft and the shift rails in the shift positions of engaged gear steps as well in order to permit shifts between two gear steps that are allocated to different input shafts to be implemented as power shifts, which is to say, without interruption of tractive force.

In automated double clutch transmission comprising two countershafts that are arranged in a V-shape together with the coaxially disposed input shafts is known from DE 101 08 881 A1, for example. In general, each of the countershafts can be connected to both input shafts via two shiftable gearwheel sets and, in one case, via only one shiftable gearwheel set. The gearwheel sets of the uneven gears are allocated to the longer, central input shaft, and the even gears and the reverse gear are allocated to the shorter input shaft, which is in the form of a hollow shaft.

The shifting device of this known double clutch transmission comprises four shift rails, each of which has an adjustment connection to the selector sleeve of a shifting group that generally has two gear clutches but, in one case, has only one gear clutch, and one selector shaft, which is disposed tangentially-normally to the shift rails and is axially displaceable via a selection actuator and is rotatable about the longitudinal axis thereof via a shifting actuator. In order to make sequential power shifts possible, the engagement openings of the shift rails are designed in such a way that the adjustment connection to the allocated selector finger of the shifting shaft can be disengaged and engaged in the neutral position and the shift positions that correspond to a selected gear. In order to activate the selector shaft accordingly, a four-position selection actuator is therefore required to axially displace the selector shaft into four selected positions, and a three-position selection actuator is required to rotate the selector shaft into three shift positions in each case. The transverse placement of the selector shaft requires a large construction space, however, and therefore cannot always be used.

Document DE 10 2004 052 804 B3 makes known a shifting device of a double clutch transmission in which a separate selector shaft is allocated to the shift rails of each sub-gearing. The selector shafts are all disposed axially parallel to the shift rails and can be rotated about the longitudinal axes thereof via a selection actuator and can be axially displaced via a shifting actuator. By rotating one of these selector shafts about the longitudinal axis thereof, a first selector finger is disengaged from the engagement opening of the allocated shift rail, and a second selector finger is brought into engagement with an engagement opening of the other allocated shift rail. Axial displacement of the selector shaft also induces axial displacement of the coupled shift rail, thereby engaging or disengaging an allocated gear. The rotational motion of the selector shaft, that forms the selection procedure for decoupling with one of the shift rails and coupling with the other shift rail, always takes place in the neutral position of the shift rails. As a result, only one two-position selection actuator and one three-position shifting actuator are required for each selector shaft. However, since the applicable components of the shifting device must be present in duplicate, the complexity and spatial requirement of this shifting device are unfavorably high.

### SUMMARY OF THE INVENTION

The present invention relates to a shifting device of an automated group transmission comprising a main gearing and a splitter group upstream thereof having at least one common countershaft, the splitter group thereof being in the form of a double clutch transmission having two coaxially disposed input shafts, each of which can be connected on the input side, via an allocated friction clutch, to the drive shaft of a drive motor and on the output side, via one or two shiftable, input stages to the countershaft. In this embodiment of the splitter group, at least one and up to two shiftable input stages are therefore allocated to each input shaft, via which they can be brought into a drive connection with the at least one common countershaft. To prevent interruption of tractive force or thrust, an allocated shifting device, in combination with a low-cost and space-saving design, should therefore make it possible to change the load-transmitting input stage as a power shift, for the purposes of which the two shifting groups of the splitter group must be shiftable independently of one another.

Such a group transmission is known from DE 10 2006 015 661 A1, for example, wherein FIG. 1 therein shows a variant embodiment comprising a single common countershaft, and FIG. 13 therein shows a variant embodiment comprising two identical common countershafts. The splitter group, which is in the form of a double clutch transmission, comprises a total of three shiftable input stages, the axially centrally disposed input stage of which can be connected to both input shafts via a clutch in each case, this is disposed in another shifting group. DE 10 2006 015 661 A1, however, does not contain any information on the design and mode of operation of an allocated shifting device, in particular for changing the load-transmitting input stage. It could be possible to provide a shifting device in which a shift rail having a single three-position shifting actuator is allocated to each of the two shifting groups, whereby it would be possible to shift the two shifting groups independently. Due to the construction space required therefore, however, it is not always possible to achieve a relatively low-cost design of a shifting device of this type.

The problem addressed by the present invention is therefore that of providing an alternative shifting device of an automated group transmission of the initially stated type, via which the shifts of the splitter group, which is in the form of a double clutch transmission, can be performed as power shifts, and which is a space-saving alternative to an embodiment having two shifting actuators.

A further problem addressed by the invention is that of providing a method for the shifting control of an automated group transmission of this type, in which a change of the load-transmitting input stage always takes place as a power shift within the splitter group.

The present problem is solved according to the invention in a general form by a shifting device of an automated group transmission comprising a main gearing and a splitter group upstream thereof having at least one common countershaft, the splitter group thereof being in the form of a double clutch transmission having two coaxially disposed input shafts, each of which can be connected on the input side, via an allocated friction clutch, to the drive shaft of a drive motor and on the output side, via at least one shiftable input stage, to the countershaft, wherein each input shaft is allocated a shift rail, each of which is disposed axially parallel and is axially displaceable, and each having an adjustment connection to the selector sleeve of an allocated shifting group via a shift fork and having at least one engagement opening, and wherein a selector shaft is disposed axially parallel to the shift rails, which comprises at least one selector finger for engaging in the engagement openings of the shift rails and being rotatable about the longitudinal axis thereof via a selection actuator, and being axially displaceable via a shifting actuator.

By way of the shifting device according to the invention, shifts can be performed to change the load-transmitting input stage within the splitter group as a power shift provided the number and arrangement of the engagement openings of the shift rails and the selector fingers of the selector shaft are suitably designed and the selection actuator and the shifting actuator are suitably displaceable. The specific design of this shifting device depends on the number and arrangement of the input stages that are present.

In a universally usable embodiment of the shifting device according to the invention, which is provided in particular for a splitter group having two shiftable input stages per input shaft, each shift rail is equipped with two engagement openings, which are approximately as wide as the allocated selector finger of the selector shaft and are separated from each other axially by twice the shift travel separation of the shifting groups and are symmetrically disposed with respect to the neutral position of the particular shift rail, and the selector shaft can be rotated in two selected positions separated by a selector angle distance, each of which corresponds to an engagement of the allocated selector finger into an engagement opening of one of the shift rails, and can be axially displaced in five shift positions, which are separated from each other axially in the shift travel separation of the shifting groups and are symmetrically disposed with respect to the neutral position of the selector shaft.

This shifting device can also be used in a structurally identical manner, of course, with a splitter group having three or only two shiftable input stages, even if all of the engagement openings of the shift rails and all of the shift positions of the selector shaft are not required. Considerable savings can be realized, however, due to the greater number of identical parts compared to version-specific embodiments of the shifting device.

In a first version-specific embodiment of the shifting device according to the invention, which is provided for a splitter group having two input stages allocated to one of the input shafts and only one input stage allocated to the other input shaft, the shift rail allocated to the two-stage shifting group is equipped with only one engagement opening, which is approximately as wide as the allocated selector finger of the selector shaft and is disposed axially in the shift travel separation of the allocated shifting group in the shifting direction of the input stage of the other shifting group from the neutral position of the applicable shift rail, the shift rail allocated to the single-stage shifting group is equipped with two engagement openings, which are approximately as wide as the allocated selector finger of the selector shaft and are separated from each other axially by twice the shift travel separation of the allocated shifting group and are symmetrically disposed with respect to the neutral position of the applicable shift rail, and the selector shaft can be rotated in two selected positions separated by a selector angle distance, each of which corresponds to an engagement of the allocated selector finger into an engagement opening of one of the shift rails, and can be axially displaced in four shift positions, which are separated from each other axially in the shift travel separation of the shifting groups, one of which lies in the neutral position of the selector shaft, two of which lie axially with respect to the neutral position of the selector shaft on the side of the common shifting direction of both shifting groups, and one lying axially with respect to the neutral position of the selector shaft on the side of the shifting direction that is present in only one shifting group.

In a second version-specific embodiment of the shifting device according to the invention, which is provided for a splitter group having two input stages allocated to one of the input shafts and only one input stage allocated to the other input shaft, the axially centrally disposed input stage of which being in the form of a start-up input stage, for example, and being connectable also to the other input shaft in an irregular manner, the shift rail allocated to the regularly two-stage shifting group is equipped with only one engagement opening, which is approximately as wide as the allocated selector finger of the selector shaft and is disposed axially in the shift travel separation of the allocated shifting group in the shifting direction of the regular input stage of the other shifting group with respect to the neutral position of the applicable shift rail, the shift rail allocated to the irregularly two-stage shifting group is equipped with two engagement openings, which are approximately as wide as the allocated selector finger of the selector shaft and are separated from each other axially by twice the shift travel separation of the shifting group and are disposed symmetrically with respect to the neutral position of the respective selector shaft, and the selector shaft can be rotated in two selected positions separated by a selector angle distance, each of which corresponds to an engagement of the allocated selector finger into an engagement opening of one of the shift rails, and can be axially displaced in four shift positions, which are separated from each other axially in the shift travel separation of the shifting groups, one of which lies in the neutral position of the selector shaft, two of which lie axially with respect to the neutral position of the selector shaft on the side of the common regular shifting direction of both shifting groups, and one lying axially with respect to the neutral position of the selector shaft on the side of the shifting direction that is present irregularly in the one shifting group.

Since shifts in the splitter group and the main gearing typically take place in a serial manner, a switching device can be provided, by way of which a common selection actuator of the main gearing and the splitter group can be shifted between an adjustment connection to a selector shaft of the main gearing and the selector shaft of the splitter group. Therefore, one fewer selection actuator is required compared to an embodiment of the shifting device having separate selection actuators.

The method-related problem for executing a change of the load-transmitting input stage as a power shift within the splitter group is solved according to the invention in that, when changing from one power input stage allocated to the one input shaft to a target input stage allocated to the other input shaft, starting from an adjustment connection of the selector shaft to the shift rail, located in the neutral position thereof, of the non-load-transmitting input shaft, this shift rail is initially axially displaced by a shift travel distance into the shift position of the target input stage, whereupon, with temporal overlap, the friction clutch allocated to the power input stage is disengaged and the friction clutch allocated to the target input stage is engaged, then, via rotation of the selector shaft by the selector angle distance, the adjustment connection of the selector shaft to the input shaft, which is now load-transmitting, is disengaged and an adjustment connection to the shift rail of the previously load-transmitting input shaft is established, and finally this shift rail is axially displaced by a shift travel distance into the neutral position thereof.

By disengaging the previously load-transmitting power input stage, it is possible to reduce the losses due to rolling in this input stage and increase the reliability of operation in terms of a potential interference in the transmission and clutch control.

When changing from a power input stage allocated to the one input shaft to a target input stage allocated to the same input shaft, it is provided, however, that a shift is initially carried out, in the same manner, into an intermediate input stage, which is allocated to the other input shaft and preferably has a middle gear ratio, and then a shift is carried out in the same manner into the target input stage, wherein the applicable shift rail is axially displaced by twice the shift travel distance when shifting the allocated shifting group from the power input stage to the target input stage.

In a passively engagable embodiment of the friction clutches, such as an embodiment as diaphragm-spring clutch, it is provided in each of the aforementioned sequences that the friction clutch allocated to the non-load-transmitting input shaft is disengaged first and then the friction clutch allocated to the previously load-transmitting input shaft is engaged. As a result, the energy required to maintain disengagement of the non-load-transmitting friction clutch can be saved and the reliability of operation in terms of a potential interference in the transmission and clutch control can be increased.

If the splitter group is provided with two input stages allocated to one of the input shafts and only one input stage allocated to the other input shaft, the axially centrally disposed input stage of which is preferably in the form of a start-up input stage and can be connected also to the other input shaft in an irregular manner, it is provided, at the beginning of a start-up procedure, with both friction clutches disengaged, a start-up input stage regularly engaged in the shifting group of one shift rail and an adjustment connection of the selector shaft to the other shift rail that is located in the neutral position thereof, that this shift rail is axially displaced by a shift travel distance into the shift position of the irregularly engaged start-up input stage, and, as a result, both friction clutches are at least partially engaged simultaneously.

By using both friction clutches simultaneously as a start-up clutch, the thermal load and mechanical wear thereof are markedly reduced, thereby substantially increasing the service life of the friction clutches.

As the start-up procedure progresses, the friction clutch allocated to the shift rail of the irregularly engaged start-up input stage is disengaged and then this shift rail is displaced axially by twice the shift travel separation into the shift position of the higher input stage of the same shifting group, whereupon, with temporal overlap, the friction clutch allocated to the start-up input stage is disengaged and the friction clutch allocated to the higher input stage is engaged, then, via rotation of the selector shaft by the selector angle distance, the adjustment connection of the selector shaft to the shift rail of the input shaft, which is now load-transmitting, is disengaged and an adjustment connection to the shift rail of the previously load-transmitting input shaft is established, and finally this shift rail is axially displaced by a shift travel distance into the neutral position thereof.

### BRIEF DESCRIPTION OF THE DRAWINGS

To illustrate the invention, a drawing having example embodiments follows the description. Shown are:

FIG. 1 a first embodiment of the shifting device, according to the invention, of the splitter group according to FIG. 2 and FIG. 3,

FIG. 2 a schematic depiction of an automated group transmission comprising a splitter group in the form of a double clutch transmission, having four shiftable input stages E1, E2, E3 and E4,

FIG. 3 the shift pattern of the splitter group according to FIG. 2.

FIGS. 4a-4d a shift sequence for changing the load-transmitting input stage from El to E2 within the shifting device according to FIG. 1,

FIGS. 5a-5d a shift sequence for changing the load-transmitting input stage from E2 to E3 within the shifting device according to FIG. 1,

FIGS. 6a-6d a shift sequence for changing the load-transmitting input stage from E3 to E4 within the shifting device according to FIG. 1,

FIGS. 7a-7d a shift sequence for changing the load-transmitting input stage from E4 to E1 within the shifting device according to FIG. 1,

FIG. 8 a second embodiment of the shifting device, according to the invention, of the splitter group according to FIG. 9 and FIG. 10,

FIG. 9 a schematic depiction of an automated group transmission comprising a splitter group in the form of a double clutch transmission, having three shiftable input stages E1, E2 and E3,

FIG. 10 the shift pattern of the splitter group according to FIG. 9.

FIGS. 11a-11d a shift sequence for changing the load-transmitting input stage from E1 to E2 within the shifting device according to FIG. 8,

FIGS. 12a-12d a shift sequence for changing the load-transmitting input stage from E2 to E3 within the shifting device according to FIG. 8,

FIGS. 13a-13f a shift sequence for changing the load-transmitting input stage from E3 to E1 within the shifting device according to FIG. 8,

FIG. 14 a third embodiment of the shifting device, according to the invention, of the splitter group according to FIG. 15 and FIG. 16,

FIG. 15 a schematic depiction of an automated group transmission comprising a splitter group in the form of a double clutch transmission, having three shiftable input stages E1, E2, E3,

FIG. 16 the shift pattern of the splitter group according to FIG. 15.

FIGS. 17a-17d a shift sequence for changing the load-transmitting input stage from E1 to E2 within the shifting device according to FIG. 14,

FIGS. 18a-18d a shift sequence for changing the load-transmitting input stage from E2 to E3 within the shifting device according to FIG. 14,

FIGS. 19a-19f a shift sequence for changing the load-transmitting input stage from E3 to E1 within the shifting device according to FIG. 14, and

FIGS. 20a-20e a shift sequence for start-up with both friction clutches and the subsequent change of the load-transmitting input stage from El to E2 within the shifting device according to FIG. 14.

### DETAILED DESCRIPTION OF THE PREFERRED EMBODIMENTS

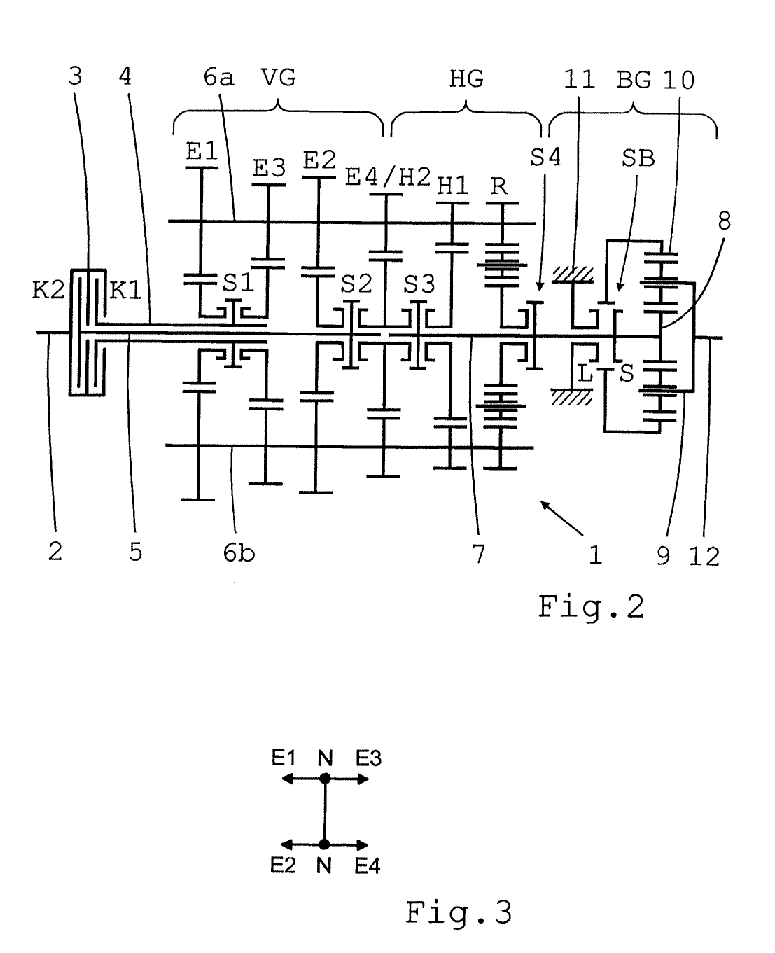

An automated group transmission 1, which is depicted schematically in FIG. 2, comprises a main gearing HG, a splitter group VG that is connected upstream thereof in a driving manner, and a range change group BG disposed downstream of the main gearing HG. The splitter group VG is in the form of a double clutch transmission comprising two coaxially disposed input shafts 4, 5.

The shorter first input shaft 4 is in the form of a hollow shaft and can be connected on the input side to the drive shaft 2 of a drive motor, which is not depicted, via a first friction clutch K1 using a common clutch drum 3. The first input shaft 4 can be connected on the output side, via two shiftable input stages E1, E3, to two identical countershafts 6a, 6b, wherein the applicable idler gears are rotatably mounted on the first input shaft 4 and the allocated clutches are combined to form a common first shifting group S1.

The longer second input shaft 5 is disposed coaxially within the first input shaft 4 and can be connected on the input side to the drive shaft 2 of the drive motor via a second friction clutch K2 using the common clutch drum 3. The second input shaft 5 can be connected on the output side, via two shiftable input stages E2, E4, to the two identical countershafts 6a, 6b, wherein the applicable idler gears are rotatably mounted on the second input shaft 5 and the allocated clutches are combined to form a common second shifting group S2.

The main gearing HG comprises a main shaft 7, which is disposed coaxially and axially adjacent to the second input shaft 5. The main shaft 7 can be connected to the two countershafts 6a, 6b via two shiftable forward main steps H1, H2 and one shiftable reverse main step R. The applicable idler gears of these gear steps H1, H2, R are rotatably supported on the main shaft 7, wherein the clutches of the forward main steps H1, H2 are combined to form a common third shifting group S3, and the clutch of the reverse main step R is contained in a fourth shifting group S4.

The second forward main step H2 is formed by the fourth input stage E4 of the splitter group VG when the flow of power on the input side takes place via one of the first three input stages E1, E2, E3, and the allocated clutch (S3) of the main gearing HG is engaged. In addition, there is a direct gear between the second input shaft 5 and the main shaft 7 when the applicable clutches (S2, S3) of the fourth input stage E4 of the splitter group VG and the second forward main step H2 of the main gearing HG are engaged.

The range change group BG is in the form of a simple planetary set, the sun gear 8 of which is connected in a rotationally fixed manner to the main shaft 7, the planet carrier 9 of which is connected in a rotationally fixed manner to the output shaft 12 of the group transmission 1, and the ring gear 10 of which is equipped with a clutch SB. In a first shift position L of the clutch SB, the ring gear 10 is held with respect to a housing component 11, thereby resulting in a gear ratio in the magnitude of 2.5 to 5.0 between the main shaft 7 and the output shaft 12 and corresponding to an engaged slow driving condition. In a second shift position S of the clutch SB, the ring gear 10 is coupled in a rotationally fixed manner to the main shaft 7, and therefore the planetary set rotates in a fixed manner thereby resulting in a gear ratio of 1.0 between the main shaft 7 and the output shaft 12 and an engaged fast driving condition.

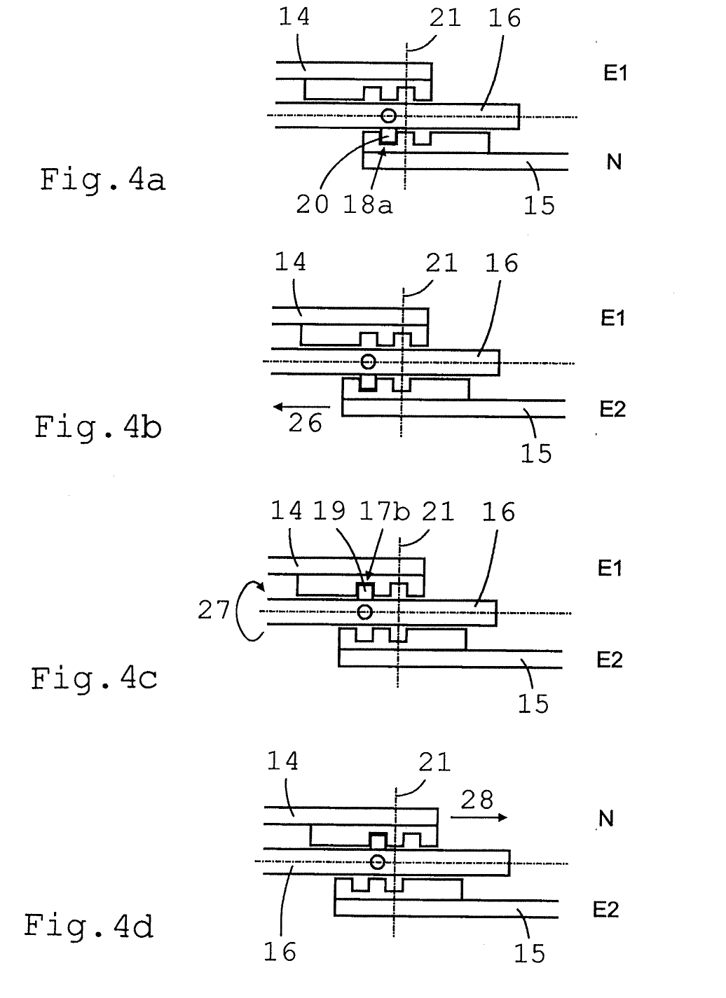

The group transmission 1 therefore has a total of sixteen forward gears and, theoretically, eight reverse gears, although all possible reverse gears are typically not used in practical application. The allocated shift pattern of the splitter group VG for shifting the input stages E1, E2, E3, E4 is shown in FIG. 3, where the letter N represents the neutral position of the transmission.

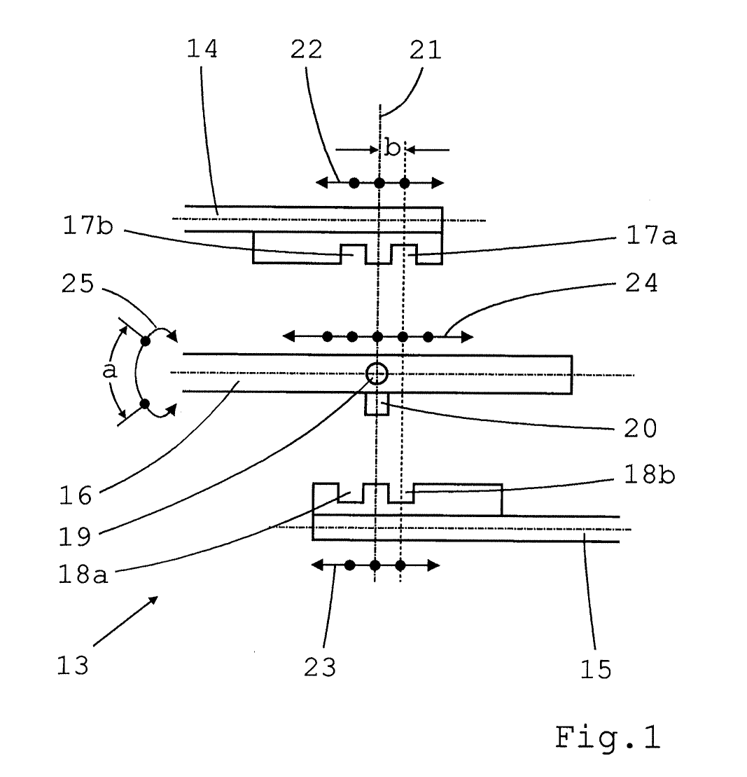

An allocated embodiment of the shifting device 13 according to the invention, via which a change of the load-transmitting input stage E1, E2, E3, E4 can be performed as a power shift within the splitter group VG, is shown in FIG. 1 in individual parts. This shifting device 13 comprises two shift rails 14, 15 disposed axially parallel adjacent to the input shafts 4, 5, and one selector shaft 16 disposed axially parallel between the shift rails 14, 15. The first shift rail 14 is allocated to the first input shaft 4 and has an adjustment connection to the first shifting group S1 via a shift fork that is not shown. The second shift rail 15 is allocated to the second input shaft 5 and has an adjustment connection to the second shifting group S2 via a shift fork that is not shown.

Both shift rails 14, 15 comprise two engagement openings 17a, 17b; 18a, 18b, which radially face the selector shaft 16. The selector shaft 16 is equipped with two selector fingers 19, 20, which, in the present case, are arranged on the selector shaft 16, offset by approximately 90° circumferentially with radial orientation. The shift rails 14, 15 and the selector shaft 16 are shown in FIG. 1 in the neutral positions thereof, which is indicated by a virtual radial plane 21, which is fixed to the housing. In the axial neutral position of the shift rails 14, 15, the allocated shifting groups are each in the neutral position N thereof, in which the allocated input stages E1, E3; E2, E4 are disengaged.

Including the particular neutral position, the shift rails 14, 15 are axially displaceable into three shift positions, which are separated from each other by the typically identical shift travel distance b of the shifting groups S1, S2 and are symmetrically disposed with respect to the neutral position. The shift positions of the shift rails 14, 15 are each indicated in FIG. 1 by solid circles in the allocated axial direction arrows 22, 23.

Each of the engagement openings 17a, 17b, 18a, 18b of the shift rails 14, 15 is approximately as wide as the allocated selector finger 19, 20 of the selector shaft 16 and are separated from each other axially by twice the shift travel distance b of the shifting groups S1, S2 and are symmetrically disposed with respect to the neutral position of the particular shift rail 14, 15. The selector shaft 16, including the neutral position thereof, can be axially displaced into a total of five shift positions (axial direction arrow 24), which are likewise separated from each other by the shift travel distance b of the shifting groups S1, S2 and are symmetrically disposed with respect to the neutral position. The shift positions of the selector shaft 16 are indicated by solid circles in the allocated axial direction arrow 24.

The selector shaft 16 can also be shifted by rotation 25 about the longitudinal axis thereof between two selected positions in each of which a selector finger 19, 20 is engaged with one of the engagement openings 17a, 17b, 18a, 18b of one of the shift rails 14, 15. The two selected positions of the selector shaft 16 are separated from each other circumferentially by the selector angle distance a of 90° in the present case, and are indicated in FIG. 1 by solid circles in the allocated rotational direction arrow 25. Accordingly, this embodiment of the shifting device 13 requires a two-position selection actuator for rotation 25 of the selector shaft 16 and a five-position shifting actuator for the axial displacement 24 of the selector shaft 16.

Although the present shifting device 13 is designed for splitter gearing VG having a total of four shiftable input stages E1, E2, E3, E4, each having two input stages E1, E3; E2, E4 per input shaft 4, 5, it may also be used in unchanged form in splitter gearings in which only one input stage is allocated to one or both input shafts 4, 5, even if all engagement openings 17a, 17b; 18a, 18b of the shift rails 14, 15 and not all shift positions (22, 23, 24) of the shift rails 14, 15 and the selector shaft 16 are used.

Based on knowledge of the invention, it goes without saying that the neutral positions of the two shift rails 14, 15 must not necessarily lie in a common radial plane 21, but can also be axially separated from each other. In this case, however, the two selector fingers 19, 20 of the selector shaft 16 would also have to be separated from each other by the same axial distance.

It is also clear that, if the selector angle distance b of the selector shaft 16 were increased accordingly, and/or if the two shift rails 14, 15 were placed closer together circumferentially about the selector shaft 16, it would be possible to obtain a correspondingly narrower placement of the two selector fingers 19, 20 circumferentially, and a single selector finger could even suffice if the neutral positions of both shift rails 14, 15 were placed in a common radial plane 21 in this case.

The function of the shifting device 13 according to the invention, as shown in FIG. 1, is explained in greater detail in the following with reference to typical shifting procedures for changing the load-transmitting input stage E1, E2, E3, E4 in the splitting group VG of the group transmission 1 according to FIG. 2.

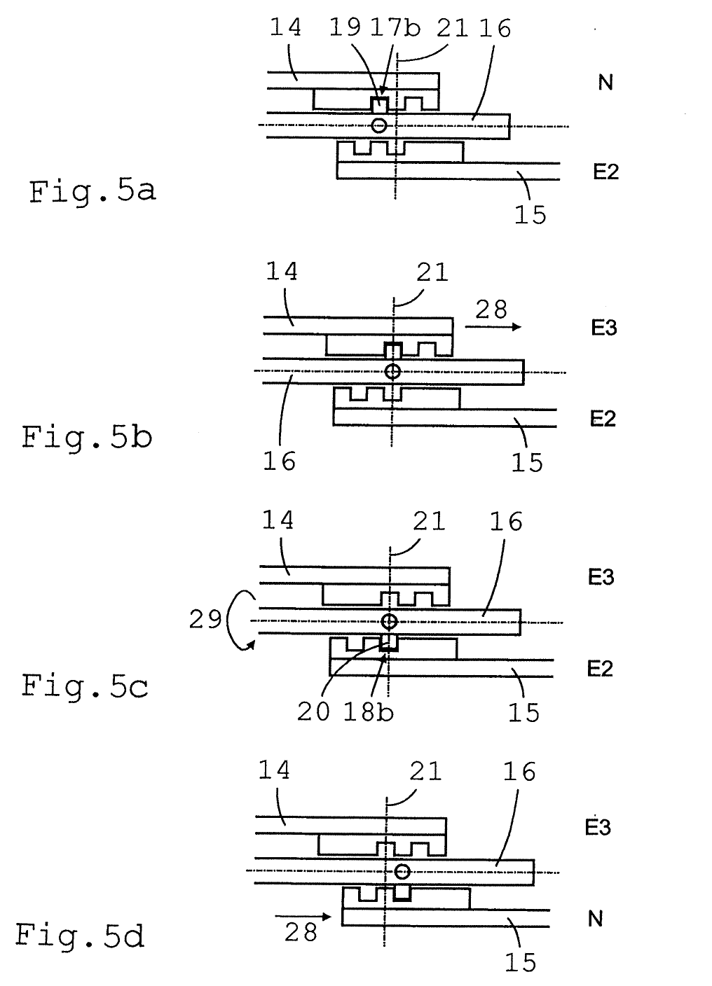

FIG. 4a to FIG. 4d show a change of the load-transmitting input stage from the first input stage El to the second input stage E2 that is carried out as a power shift. In the starting position of the shift elements 14, 15, 16 of this shifting, the first shift rail 14 is located in the shift position of the first input stage El and the second shift rail 15 is located in the neutral position N thereof (see FIG. 4a). As a result, the outer engagement opening 17a of the first shift rail 14 lies in the reference plane 21, and the two engagement openings 18a, 18b of the second shift rail 15 are located symmetrically axially on either side of the reference plane 21. The selector shaft 16 is displaced by the shift travel distance b in the direction of the first shifting group S1 and is rotated into selected position in which the second selector finger 20 is engaged with the outer engagement opening 18a of the second shift rail 15.

After the second friction clutch K2 is disengaged, if necessary, then, in a first step of the shifting according to FIG. 4b, the second shift rail 15 is displaced axially via the selector shaft 16 by a shift travel distance b in the direction of the first shifting group S1, which is to say to the left in the drawing as indicated by the arrow 26, thereby engaging the second input stage E2, which is to say, coupling the allocated idler gear to the second input shaft 5 in a rotationally fixed manner. The transmission of force from the first input stage E1 to the second input stage E2 is then changed by disengaging the first friction clutch K1 and engaging the second friction clutch K2 with temporal overlap.

The selector shaft 16 is then rotated by a selector angle distance a in the direction of the first shift rail 14 as indicated by the arrow 27, thereby disengaging the adjustment connection of the selector shaft 16 to the second shift rail 15 and engaging the first selector finger 19 with the inner engagement opening 17b of the first shift rail 14 (see FIG. 4c).

Next, the first shift rail 14 is displaced axially via the selector shaft 16 by a shift travel distance b in the direction of the second shifting group S2 as indicated by the arrow 28, thereby disengaging the first input stage E1, which is to say, decoupling the first allocated idler gear from the first input shaft 4 and moving the first shift rail 14 into the neutral position N thereof (see FIG. 4d). The first friction clutch K1 is then engaged if necessary.

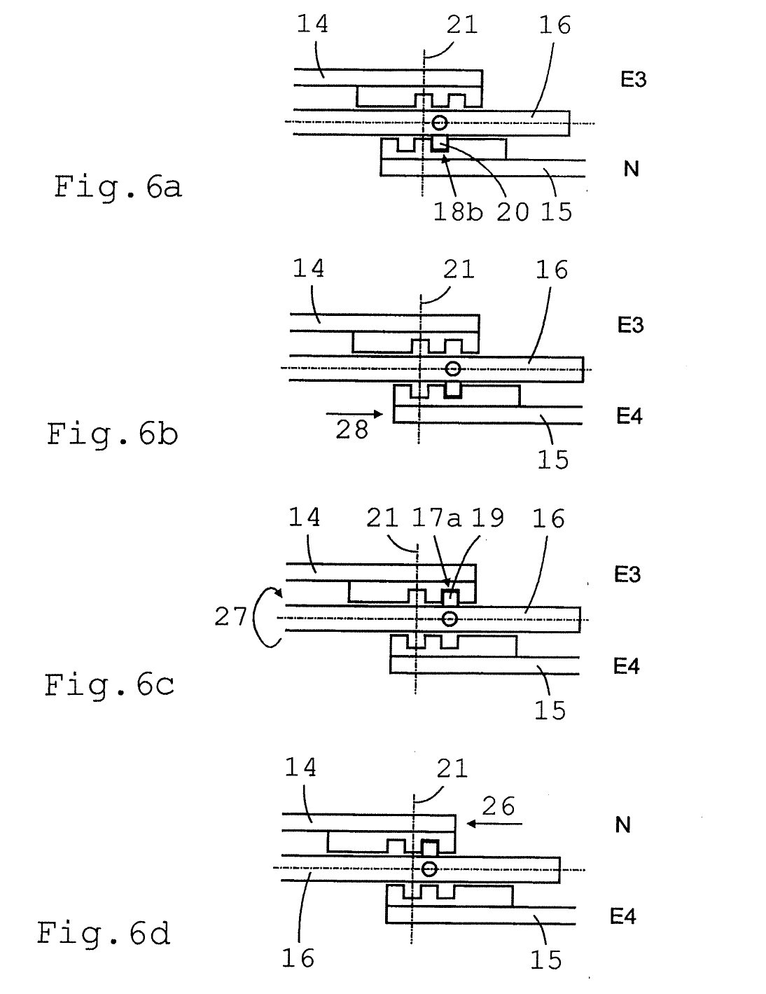

FIG. 5a to FIG. 5d show a change of the load-transmitting input stage from the second input stage E2 to the third input stage E3 that is carried out as a power shift, wherein the starting position of the shift elements 14, 15, 16 of this shifting according to FIG. 5a corresponds to the end position of the previously described shifting according to FIG. 4d.

After the first friction clutch K1 is disengaged, if necessary, then, in a first step of the shifting according to FIG. 5b, the first shift rail 14 is displaced axially via the selector shaft 16 by a shift travel distance b in the direction of the second shifting group S2 as indicated by the arrow 28, thereby engaging the third input stage E3. The transmission of force from the second input stage E2 to the third input stage E3 is then changed by disengaging the second friction clutch K2 and engaging the first friction clutch K1 with temporal overlap.

Next, as shown in FIG. 5c, the selector shaft 16 is rotated by a selector angle distance a according to arrow 29 in the direction of the second shift rail 15, thereby disengaging the adjustment connection of the selector shaft 16 to the first shift rail 14 and engaging the second selector finger 20 with the inner engagement opening 18b of the second shift rail 15.

Next, the second shift rail 15 is displaced axially via the selector shaft 16 by a shift travel distance b in the direction of the second shifting group S2 as indicated by the arrow 28, thereby disengaging the second input stage E2 and moving the second shift rail 15 into the neutral position N thereof (see FIG. 5d). The second friction clutch K2 is then engaged if necessary.

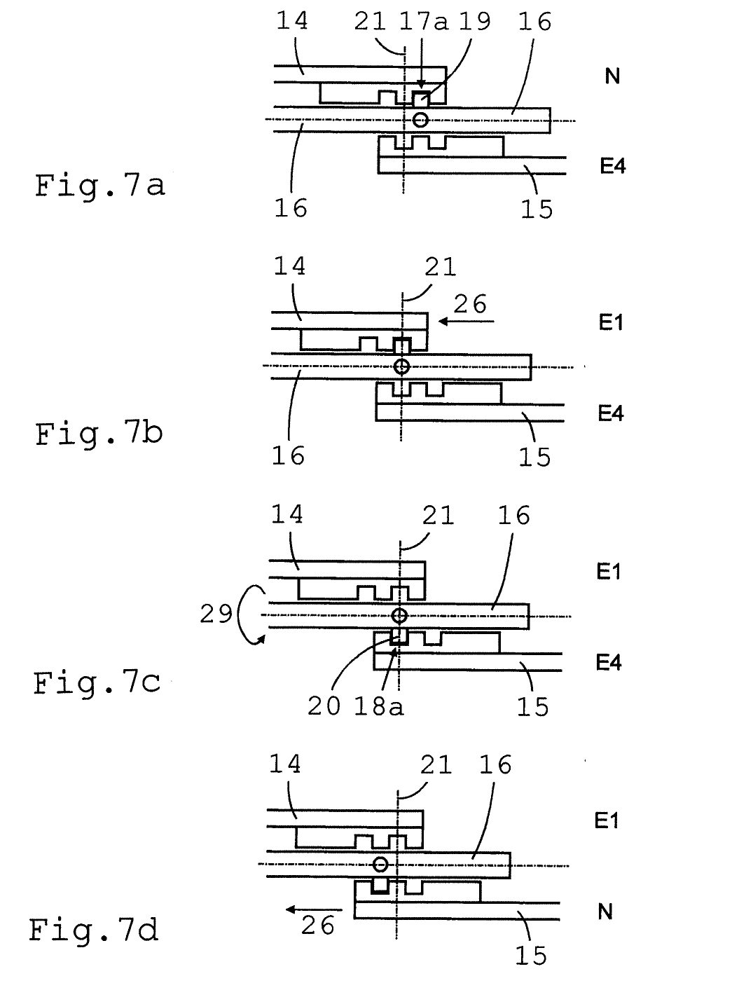

FIG. 6a to FIG. 6d show a change of the load-transmitting input stage from the third input stage E3 to the fourth input stage E4 that is carried out as a power shift, wherein the starting position of the shift elements 14, 15, 16 of this shifting according to FIG. 6a corresponds to the end position of the previously described shifting according to FIG. 5d.

After the second friction clutch K2 is disengaged, if necessary, then, in a first step of the shifting according to FIG. 6b, the second shift rail 15 is displaced axially via the selector shaft 16 by a shift travel distance b in the direction of the second shifting group S2 as indicated by the arrow 28, thereby engaging the fourth input stage E4. The transmission of force from the third input stage E3 to the fourth input stage E4 is then changed by disengaging the first friction clutch K1 and engaging the second friction clutch K2 with temporal overlap.

The selector shaft 16 is then rotated by a selector angle distance a in the direction of the first shift rail 14 as indicated by the arrow 27, thereby disengaging the adjustment connection of the selector shaft 16 to the second shift rail 15 and engaging the first selector finger 19 with the outer engagement opening 17a of the first shift rail 14 (see FIG. 6c).

Next, the first shift rail 14 is displaced axially via the selector shaft 16 by a shift travel distance b in the direction of the first shifting group S1 as indicated by the arrow 26, thereby disengaging the third input stage E3 and moving the first shift rail 14 into the neutral position N thereof (see FIG. 6d). The first friction clutch K1 is then engaged if necessary.

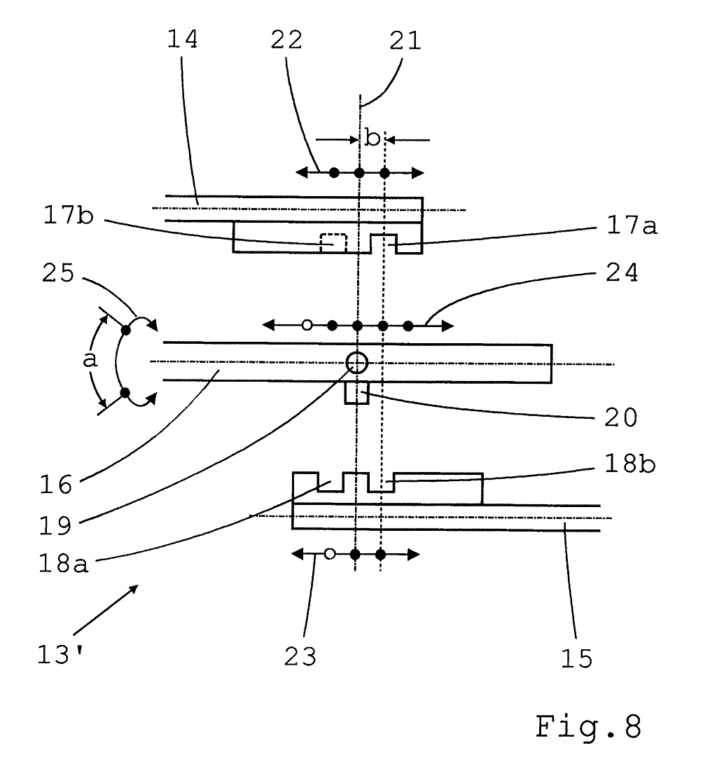

FIG. 7a to FIG. 7d show a change of the load-transmitting input stage from the fourth input stage E4 to the first input stage El that is carried out as a power shift, and is typically carried out in combination with an upshift within the main gearing HG. The starting position of the shifting elements 14, 15, 16 of this shifting according to FIG. 7a corresponds to the end position of the previously described shifting according to FIG. 6d.

After the first friction clutch K1 is disengaged, if necessary, then, in a first step of the shifting according to FIG. 7b, the first shift rail 14 is displaced axially via the selector shaft 16 by a shift travel distance b in the direction of the first shifting group S1 as indicated by the arrow 26, thereby engaging the first input stage E1. The transmission of force from the fourth input stage E4 to the first input stage E1 is then changed by disengaging the second friction clutch K2 and engaging the first friction clutch K1 with temporal overlap.

Next, the selector shaft 16 is rotated by a selector angle distance a in the direction of the second shift rail 15 according to the arrow 29, thereby disengaging the adjustment connection of the selector shaft 16 to the first shift rail 14 and engaging the second selector finger 20 with the outer engagement opening 18a of the second shift rail 15 (see FIG. 7c).

Next, the second shift rail 15 is displaced axially via the selector shaft 16 by a shift travel distance b in the direction of the first shifting group S1 as indicated by the arrow 26, thereby disengaging the fourth input stage E4 and moving the second shift rail 15 into the neutral position N thereof (see FIG. 7d). The second friction clutch K2 is then engaged if necessary.

To reverse the above-described shifting procedures, which is to say, to change the load-transmitting input stage from the second input stage E2 to the first input stage E1, from the third input stage E3 to the second input stage E2, from the fourth input stage E4 to the third input stage E3, and from the first input stage El to the fourth input stage E4, it is only necessary to implement the applicable shifting steps in the reverse order and reverse the particular direction of motion of the axial displacements and the rotational motions of the selector shaft 16.

An automated group transmission 1′, which is depicted schematically in FIG.

9, differs from the previously described group transmission 1 according to FIG. 2 in that the splitter group VG′ now has only three shiftable input stages E1, E2, E3. To this end, the second, central input shaft 5 can be connected at the output side to the two countershafts 6a, 6b only via a single shiftable input stage E2, which is located with respect to the gear ratio thereof between the two input stages E1, E3 of the first input shaft 4. As a result, the shifting group S2′ allocated to the second input shaft 5 contains only the clutch of the second input stage E2. Due to the arrangement of the input stages E1, E2, E3, the second input stage E2 now acts as the second forward main step H2 when the input-side flow of power takes place via the first input stage E1 or the third input stage E3, and the allocated clutch (S3) of the main gearing HG is engaged.

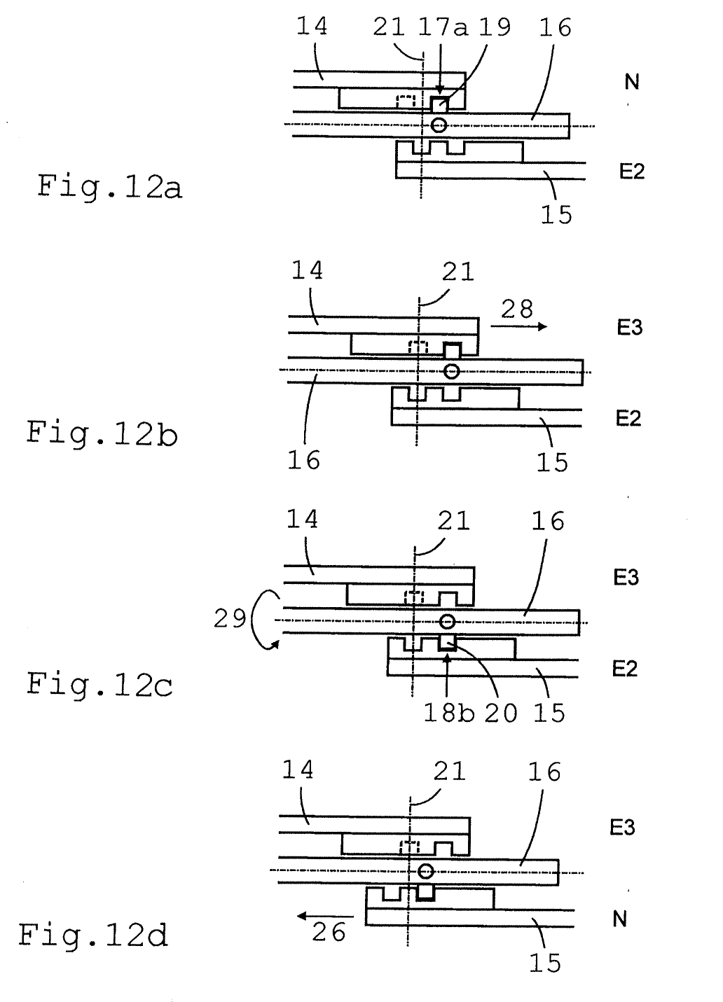

The group transmission 1′ therefore comprises a total of twelve forward gears and, theoretically, six reverse gears. The allocated shift pattern of the splitter group VG′ for shifting the input stages E1, E2, E3 is depicted in FIG. 10.

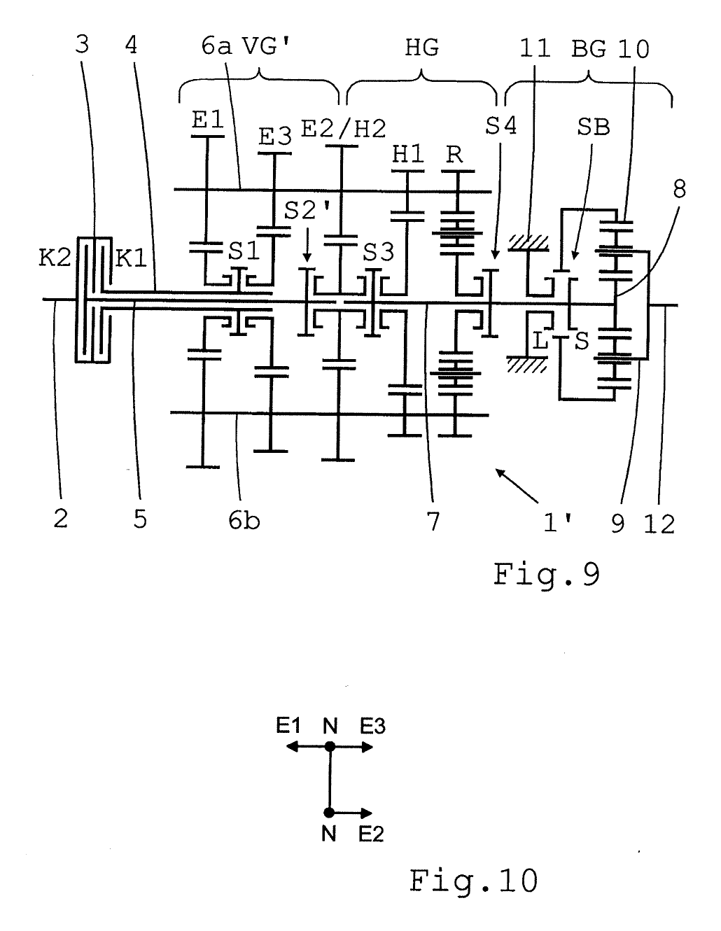

An allocated embodiment of the shifting device 13′ according to the invention, via which a change of the load-transmitting input stage E1, E2, E3 can be performed as a power shift within the splitter group VG′, is shown in FIG. 8 in individual parts. This shifting device 13′ differs from the above-described shifting device 13 according to FIG. 1 only in that the inner engagement opening 17b of the first shift rail 14 and the outer shift position of the selector shaft 16, which faces the first shifting group S1, are not required. The inner engagement opening 17b of the first shift rail 14, which is depicted as a dashed line in FIG. 8, can therefore be selectively omitted or retained in order to obtain a larger number of identical parts. Due to the elimination of the shift position of the selector shaft 16, which is indicated by an empty circle in the axial direction arrow 24, a less complex four-position shifting actuator is sufficient with this shifting device 13′.

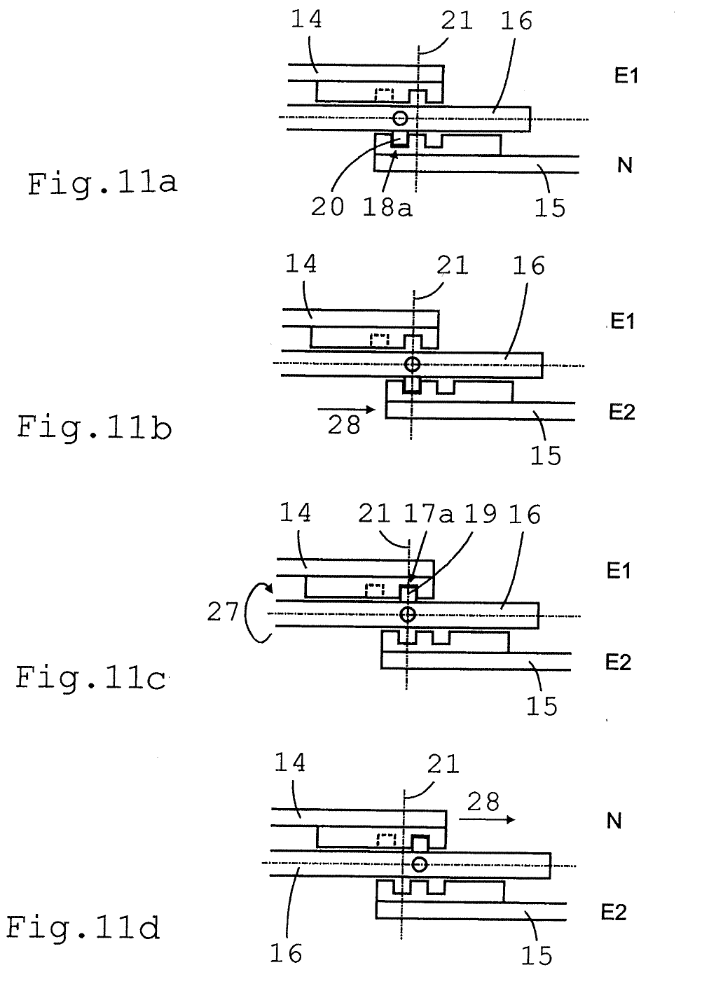

The function of the shifting device 13′ according to the invention, as shown in FIG. 8, is explained in greater detail in the following with reference to typical shifting procedures for changing the load-transmitting input stage E1, E2, E3 in the splitting group VG′ of the group transmission 1′ according to FIG. 9.

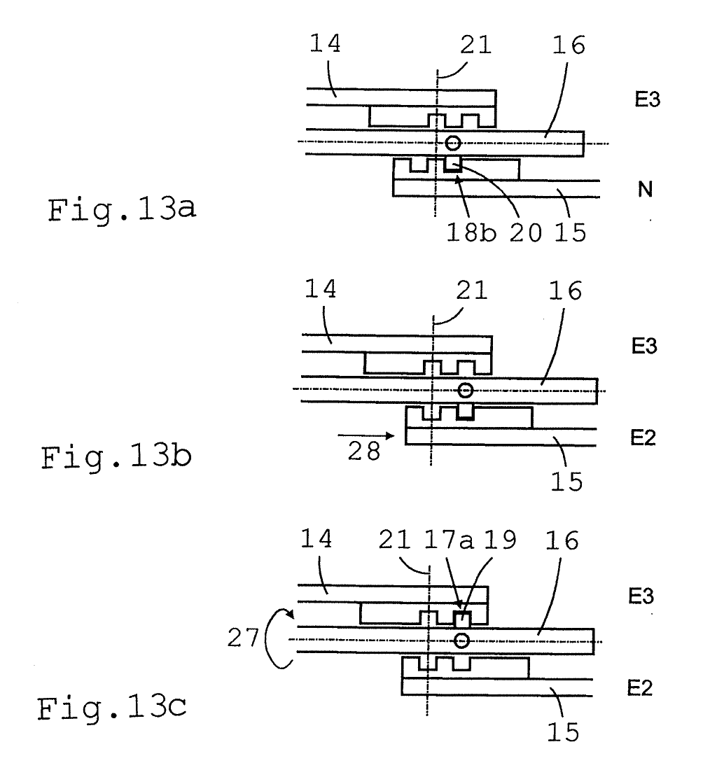

FIG. 11a to FIG. 11d show a change of the load-transmitting input stage from the first input stage E1 to the second input stage E2 that is carried out as a power shift. In the starting position of the shift elements 14, 15, 16 of this shifting, the first shift rail 14 is located in the shift position of the first input stage E1 and the second shift rail 15 is located in the neutral position N thereof (see FIG. 11a). As a result, the outer engagement opening 17a of the first shift rail 14 lies in the reference plane 21, and the engagement openings 18a, 18b of the second shift rail 15 are located symmetrically axially on either side of the reference plane 21. The selector shaft 16 is displaced by the shift travel distance b in the direction of the first shifting group S1 and is rotated into selected position in which the second selector finger 20 is engaged with the outer engagement opening 18a of the second shift rail 15.

After the second friction clutch K2 is disengaged, if necessary, then, in a first step of the shifting according to FIG. 11b, the second shift rail 15 is displaced axially via the selector shaft 16 by a shift travel distance b in the direction of the second shifting group S2′ as indicated by the arrow 28, thereby engaging the second input stage E2. The transmission of force from the first input stage E1 to the second input stage E2 is then changed by disengaging the first friction clutch K1 and engaging the second friction clutch K2 with temporal overlap.

The selector shaft 16 is then rotated by a selector angle distance a in the direction of the first shift rail 14 as indicated by the arrow 27, thereby disengaging the adjustment connection of the selector shaft 16 to the second shift rail 15 and engaging the first selector finger 19 with the outer engagement opening 17a of the first shift rail 14 (see FIG. 11c).

Next, the first shift rail 14 is displaced axially via the selector shaft 16 by a shift travel distance b in the direction of the second shifting group S2′ as indicated by the arrow 28, thereby disengaging the first input stage E1 and moving the first shift rail 14 into the neutral position N thereof (see FIG. 11d). The first friction clutch K1 is then engaged if necessary.

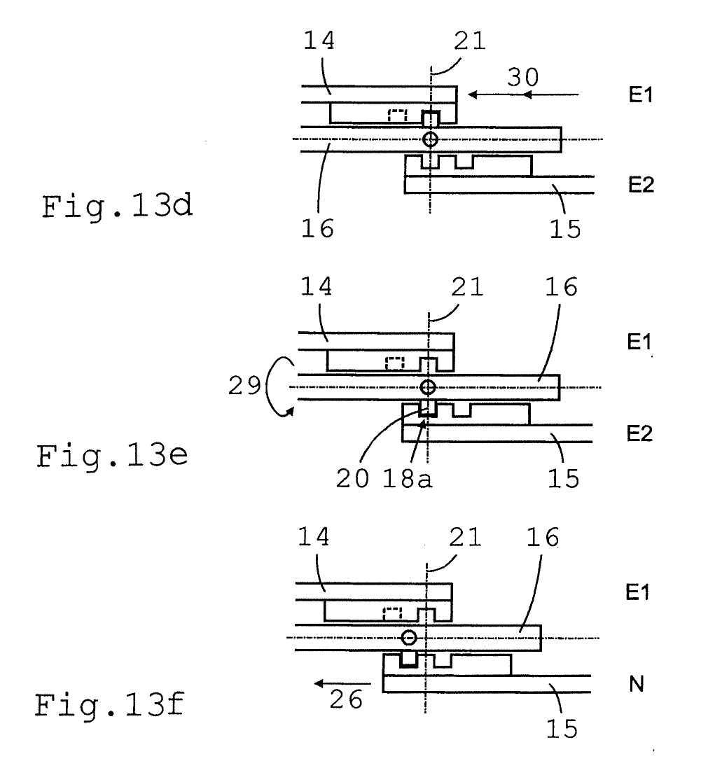

FIG. 12a to FIG. 12d show a change of the load-transmitting input stage from the second input stage E2 to the third input stage E3 that is carried out as a power shift, wherein the starting position of the shift elements 14, 15, 16 of this shifting according to FIG. 12a corresponds to the end position of the previously described shifting according to FIG. 11d.

After the first friction clutch K1 is disengaged, if necessary, then, in a first step of the shifting according to FIG. 12b, the first shift rail 14 is displaced axially via the selector shaft 16 by a shift travel distance b in the direction of the second shifting group S2′ as indicated by the arrow 28, thereby engaging the third input stage E3. The transmission of force from the second input stage E2 to the third input stage E3 is then changed by disengaging the second friction clutch K2 and engaging the first friction clutch K1 with temporal overlap.

Next, the selector shaft 16 is rotated by a selector angle distance a in the direction of the second shift rail 15 according to the arrow 29, thereby disengaging the adjustment connection of the selector shaft 16 to the first shift rail 14 and engaging the second selector finger 20 with the inner engagement opening 18b of the second shift rail 15 (see FIG. 12c).

Next, the second shift rail 15 is displaced axially 26 via the selector shaft 16 by a shift travel distance b in the direction of the first shifting group S1, thereby disengaging the second input stage E2 and moving the second shift rail 15 into the neutral position N thereof (see FIG. 12d). The second friction clutch K2 is then engaged if necessary.

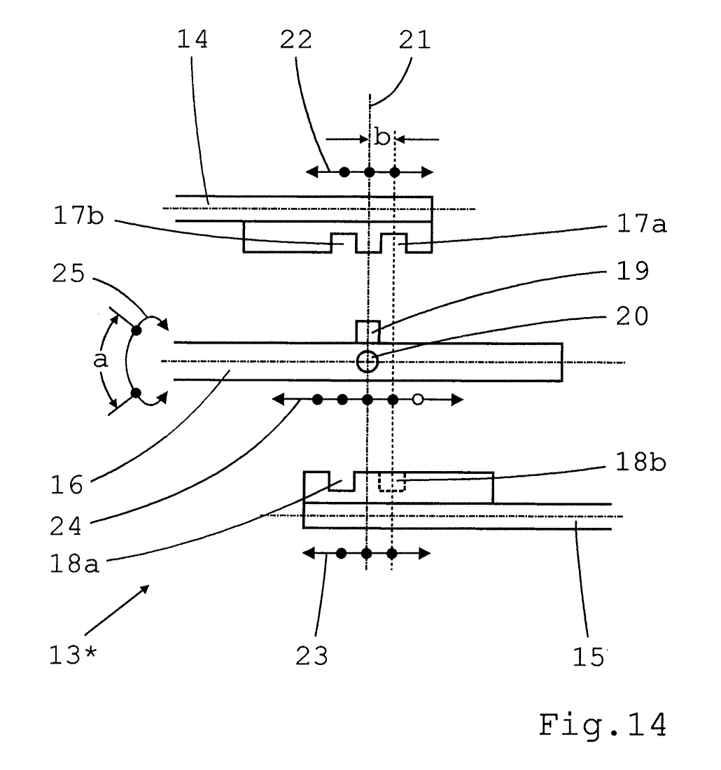

FIG. 13a to FIG. 13f show a change of the load-transmitting input stage from the third input stage E3 to the first input stage E1 that is carried out as a power shift, and is typically carried out in combination with an upshift within the main gearing HG. The starting position of the shifting elements 14, 15, 16 of this shifting according to FIG. 13a corresponds to the end position of the previously described shifting according to FIG. 12d.

After the second friction clutch K2 is disengaged, if necessary, then, in a first step of the shifting according to FIG. 13b, the second shift rail 15 is displaced axially via the selector shaft 16 by a shift travel distance b in the direction of the second shifting group S2′ as indicated by the arrow 28, thereby engaging the second input stage E2. The transmission of force from the third input stage E3 to the second input stage E2 is then changed by disengaging the first friction clutch K1 and at least partially engaging the second friction clutch K2 with temporal overlap.

The selector shaft 16 is then rotated by a selector angle distance a in the direction of the first shift rail 14 as indicated by the arrow 27, thereby disengaging the adjustment connection of the selector shaft 16 to the second shift rail 15 and engaging the first selector finger 19 with the outer engagement opening 17a of the first shift rail 14 (see FIG. 13c).

Next, the first shift rail 14 is displaced axially via the selector shaft 16 by twice the shift travel distance 2*b in the direction of the first shifting group S1 as indicated by the arrow 30, thereby disengaging the third input stage E3 and engaging the first input stage E1 (see FIG. 13d). The transmission of force from the second input stage E2 to the first input stage E1 is then changed by disengaging the second friction clutch K2 and engaging the first friction clutch K1 with temporal overlap.

Next, the selector shaft 16 is rotated by a selector angle distance a in the direction of the second shift rail 15 according to the arrow 29, thereby disengaging the adjustment connection of the selector shaft 16 to the first shift rail 14 and engaging the second selector finger 20 with the outer engagement opening 18a of the second shift rail 15 (see FIG. 13e).

Next, the second shift rail 15 is displaced axially via the selector shaft 16 by a shift travel distance b in the direction of the first shifting group S1 as indicated by the arrow 26, thereby disengaging the second input stage E2 and moving the second shift rail 15 into the neutral position N thereof (see FIG. 13f). The second friction clutch K2 is then engaged if necessary.

To reverse the above-described shifting procedures, which is to say, to change the load-transmitting input stage from the second input stage E2 to the first input stage E1, from the third input stage E3 to the second input stage E2, and from the first input stage El to the third input stage E3, it is only necessary to implement the applicable shifting steps in the reverse order and reverse the particular direction of motion of the axial displacements and the rotational motions of the selector shaft 16.

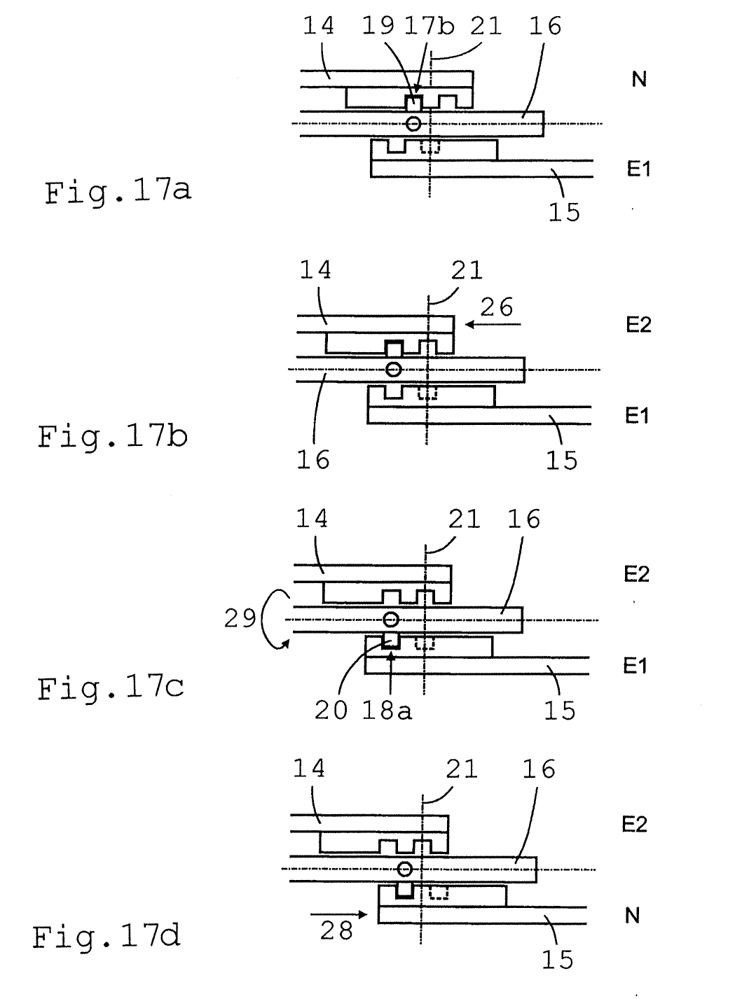

An automated group transmission 1*, which is depicted schematically in FIG. 15, differs from the previously described group transmission 1′ according to FIG. 9 in that the allocation of the input stages E1, E2, E3 to the input shafts 4, 5 and, therefore, to the applicable shifting groups S1*, S2* is reversed. In addition, the first input stage E1, which is now disposed axially in the middle, can also be coupled to the first input shaft 4 in an irregular manner, which is to say for certain special functions.

As a result, the second shifting group S2* comprises two clutches for the regular shifting of the first input stage El and the third input stage E3 and the first shifting group S1* comprises two clutches for the regular shifting of the second input stage E2 and for the irregular shifting of the first input stage E1. Due to this arrangement of the input stages E1, E2, E3, the third input stage E3 now also acts as the second forward main step H2 of the main gearing HG when the flow of power on the input side takes place via one of the first two input stages E1, E2 and the allocated clutch (S3) of the main gearing HG is engaged.

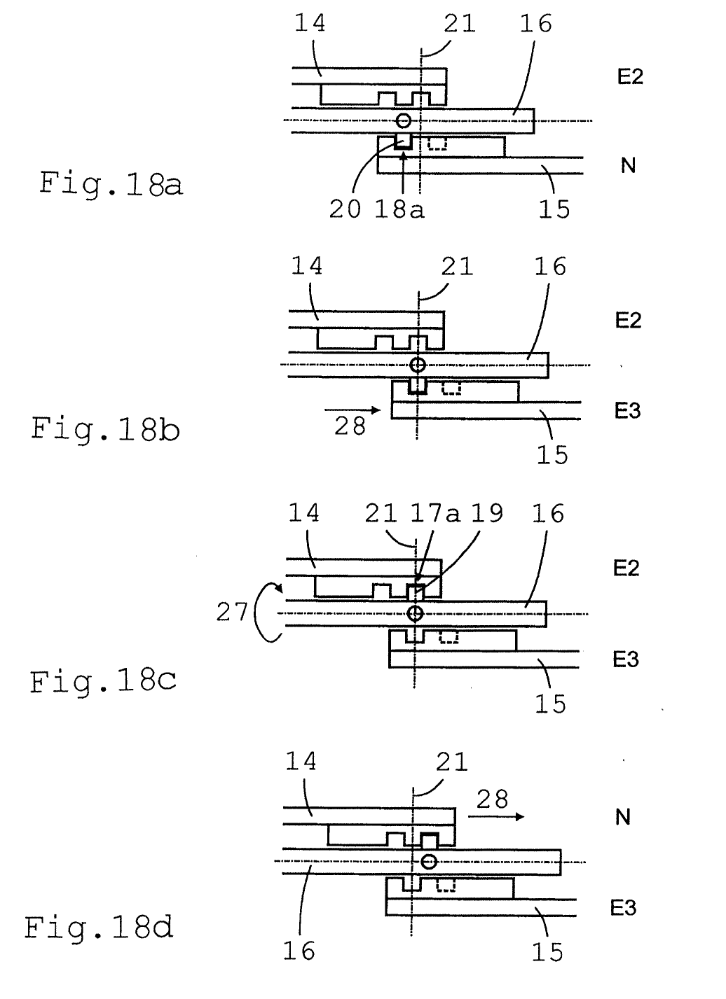

This group transmission 1* likewise comprises a total of twelve forward gears and, theoretically, six reverse gears. The allocated shift pattern of the splitter group VG* for shifting the input stages E1, E2, E3 is depicted in FIG. 16, wherein the irregular shift position of the first input stage El via the first shifting group S1* is labeled with E1*.

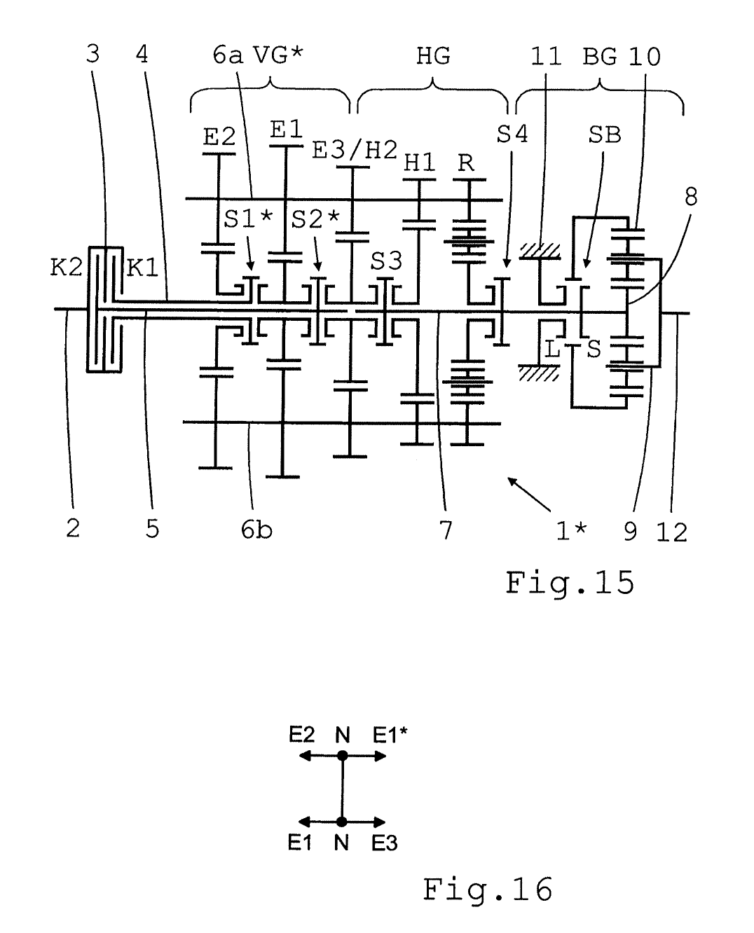

An allocated embodiment of the shifting device 13* according to the invention, via which a change of the load-transmitting input stage E1, E2, E3 can be performed as a power shift within the splitter group VG* is shown in FIG. 14 in individual parts. This shifting device 13* differs from the above-described shifting device 13 according to FIG. 1 only in that the inner engagement opening 18b of the second shift rail 15 and the outer shift position of the selector shaft 16, which faces the second shifting group S2*, are not required. The inner engagement opening 18b of the second shift rail 15, which is indicated as a dashed line in FIG. 14, can therefore be selectively omitted or retained without functionality. Due to the elimination of the shift position of the selector shaft 16, which is indicated by an empty circle in the axial direction arrow 24, only a four-position shifting actuator is required for this shifting device 13* as well.

The function of the shifting device 13* according to the invention, which is shown in FIG. 14, is explained in greater details in the following with reference to typical shifting procedures for changing the load-transmitting input stage E1, E2, E3 in the splitter group VG* of the group transmission 1* according to FIG. 15 and for start-up with both friction clutches K1, K2 and a subsequent change into the second input stage E2.

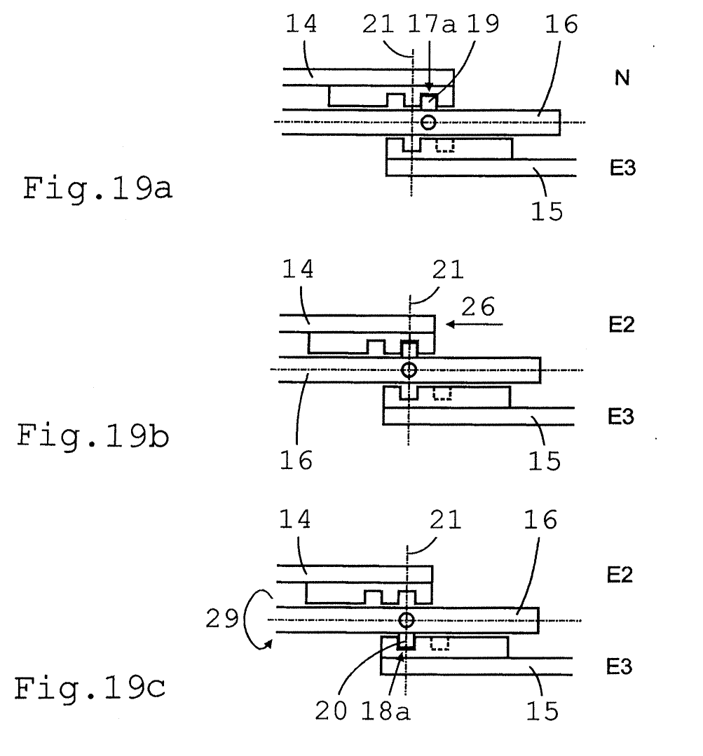

FIG. 17a to FIG. 17d show a change of the load-transmitting input stage from the first input stage El to the second input stage E2 that is carried out as a power shift. In the starting position of the shift elements 14, 15, 16 of this shifting, the first shift rail 14 is located in the neutral position N thereof and the second shift rail is located in the shift position of the first input stage E1 (see FIG. 17a). As a result, the inner engagement opening 18b of the second shift rail 15 lies in the reference plane 21, and the engagement openings 17a, 17b of the first shift rail 14 are located symmetrically axially on either side of the reference plane 21. The selector shaft 16 is displaced by a shift travel distance b in the direction of the first shifting group S1* and is rotated into selected position in which the first selector finger 19 is engaged with the inner engagement opening 17b of the first shift rail 14.

After the first friction clutch K1 is disengaged, if necessary, then, in a first step of the shifting according to FIG. 17b, the first shift rail 14 is displaced axially via the selector shaft 16 by a shift travel distance b in the direction of the first shifting group S1* as indicated by the arrow 26, thereby engaging the second input stage E2. The transmission of force from the first input stage E1 to the second input stage E2 is then changed by disengaging the second friction clutch K2 and engaging the first friction clutch K1 with temporal overlap.

Next, the selector shaft 16 is rotated by a selector angle distance a in the direction of the second shift rail 15 according to the arrow 29, thereby disengaging the adjustment connection of the selector shaft 16 to the first shift rail 14 and engaging the second selector finger 20 with the outer engagement opening 18a of the second shift rail 15 (see FIG. 17c).

Next, the second shift rail 15 is displaced axially via the selector shaft 16 by a shift travel distance b in the direction of the second shifting group S2* as indicated by the arrow 28, thereby disengaging the first input stage El and moving the second shift rail 15 into the neutral position N thereof (see FIG. 17d). The second friction clutch K2 is then engaged if necessary.

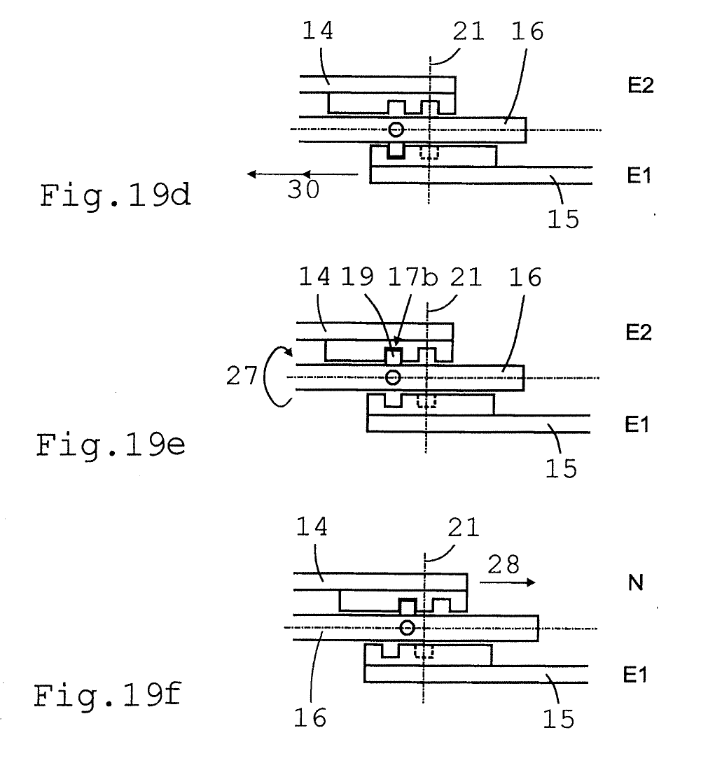

FIG. 18a to FIG. 18d show a change of the load-transmitting input stage from the second input stage E2 to the third input stage E3 that is carried out as a power shift, wherein the starting position of the shift elements 14, 15, 16 of this shifting according to FIG. 18a corresponds to the end position of the previously described shifting according to FIG. 17d.

After the second friction clutch K2 is disengaged, if necessary, then, in a first step of the shifting according to FIG. 18b, the second shift rail 15 is displaced axially via the selector shaft 16 by a shift travel distance b in the direction of the second shifting group S2* as indicated by the arrow 28, thereby engaging the third input stage E3. The transmission of force from the second input stage E2 to the third input stage E3 is then changed by disengaging the first friction clutch K1 and engaging the second friction clutch K2 with temporal overlap.

The selector shaft 16 is then rotated by a selector angle distance a in the direction of the first shift rail 14 as indicated by the arrow 27, thereby disengaging the adjustment connection of the selector shaft 16 to the second shift rail 15 and engaging the first selector finger 19 with the outer engagement opening 17a of the first shift rail 14 (see FIG. 18c).

Next, the first shift rail 14 is displaced axially via the selector shaft 16 by a shift travel distance b in the direction of the second shifting group S2* as indicated by the arrow 28, thereby disengaging the second input stage E2 and moving the first shift rail 14 into the neutral position N thereof (see FIG. 18d). The first friction clutch K1 is then engaged if necessary.

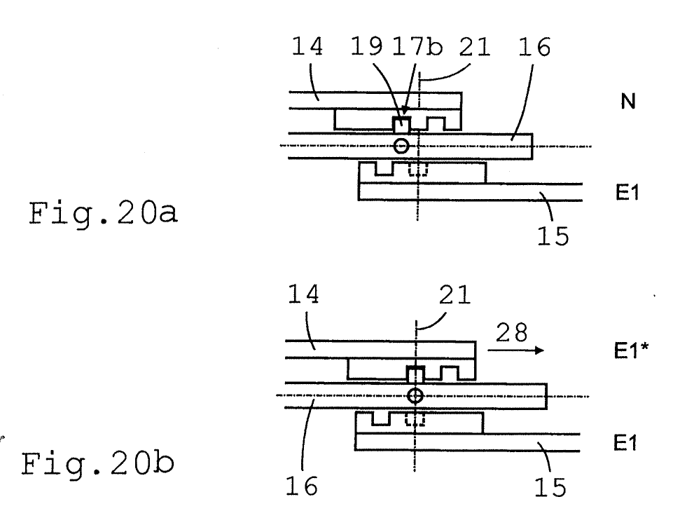

FIG. 19a to FIG. 19f show a change of the load-transmitting input stage from the third input stage E3 to the first input stage E1 that is carried out as a power shift, and is typically carried out in combination with an upshift within the main gearing HG. The starting position of the shifting elements 14, 15, 16 of this shifting according to FIG. 19a corresponds to the end position of the previously described shifting according to FIG. 18d.

After the first friction clutch K1 is disengaged, if necessary, then, in a first step of the shifting according to FIG. 19b, the first shift rail 14 is displaced axially via the selector shaft 16 by a shift travel distance b in the direction of the first shifting group S1* as indicated by the arrow 26, thereby engaging the second input stage E2. The transmission of force from the third input stage E3 to the second input stage E2 is then changed by disengaging the second friction clutch K2 and at least partially engaging the first friction clutch K1 with temporal overlap.

Next, the selector shaft 16 is rotated by a selector angle distance a in the direction of the second shift rail 15 according to the arrow 29, thereby disengaging the adjustment connection of the selector shaft 16 to the first shift rail 14 and engaging the second selector finger 20 with the outer engagement opening 18a of the second shift rail 15 (see FIG. 19c).

Next, the second shift rail 15 is displaced axially via the selector shaft 16 by twice the shift travel distance 2*b in the direction of the first shifting group S1* as indicated by the arrow 30, thereby disengaging the third input stage E3 and engaging the first input stage E1 (see FIG. 19d). The transmission of force from the second input stage E2 to the first input stage E1 is then changed by disengaging the first friction clutch K1 and engaging the second friction clutch K2 with temporal overlap.

The selector shaft 16 is then rotated by a selector angle distance a in the direction of the first shift rail 14 as indicated by the arrow 27, thereby disengaging the adjustment connection of the selector shaft 16 to the second shift rail 15 and engaging the first selector finger 19 with the inner engagement opening 17b of the first shift rail 14 (see FIG. 19e).

Next, the first shift rail 14 is displaced axially via the selector shaft 16 by a shift travel distance b in the direction of the second shifting group S2* as indicated by the arrow 28, thereby disengaging the second input stage E2 and moving the first shift rail 14 into the neutral position N thereof (see FIG. 19f). The first friction clutch K1 is then engaged if necessary.

To reverse the above-described shifting procedures, which is to say, to change the load-transmitting input stage from the second input stage E2 to the first input stage E1, from the third input stage E3 to the second input stage E2, and from the first input stage E1 to the third input stage E3, it is only necessary to implement the applicable shifting steps in the reverse order and reverse the particular direction of motion of the axial displacements and the rotational motions of the selector shaft 16.

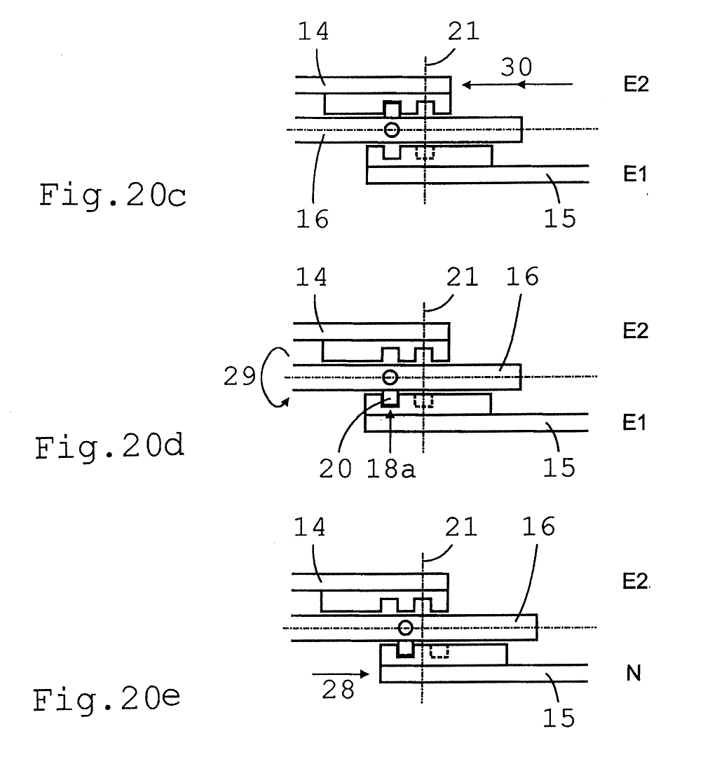

FIG. 20a to FIG. 20e show the shifting for start-up using both friction clutches K1, K2 via the first input stage E1 and the change into the second input stage E2 as a power shift for further start-up, wherein the starting position of the shift elements 14, 15, 16 of this shifting according to FIG. 20a corresponds to the starting position of the previously described shifting according to FIG. 17f.

To start the drive motor, the second friction clutch K2 is first disengaged, if necessary. To permit the first friction clutch K1 to be used as a start-up clutch as well, it is first disengaged, if necessary. Next, the first shift rail 14 is displaced axially via the selector shaft 16 by a shift travel distance b in the direction of the second shifting group S2* as indicated by the arrow 28, thereby also engaging the first input stage El in the first shifting group S1* and coupling it with the first input shaft 4 (see FIG. 20b). This is followed by the first phase of start-up by simultaneously engaging both friction clutches K1, K2.

To further accelerate the relevant motor vehicle during the start-up procedure, the first friction clutch K1 is disengaged and then the first shift rail 14 is displaced axially via the selector shaft 16 by twice the shift travel distance 2*b in the direction of the first shifting group S1* as indicated by the arrow 30, thereby disengaging the coupling of the first input stage E1 with the first, hollow cylindrical input shaft 4 and engaging the second input stage E2 (see FIG. 20c). The transmission of force from the first input stage E1 (and the second input shaft 5) to the second input stage E2 (and the first input shaft 4) is then changed by disengaging the second friction clutch K2 and engaging the first friction clutch K1 with temporal overlap.

Next, the selector shaft 16 is rotated by a selector angle distance a in the direction of the second shift rail 15 according to the arrow 29, thereby disengaging the adjustment connection of the selector shaft 16 to the first shift rail 14 and engaging the second selector finger 20 with the outer engagement opening 18a of the second shift rail 15 (see FIG. 20d).

Next, the second shift rail 15 is displaced axially via the selector shaft 16 by a shift travel distance b in the direction of the second shifting group S2* as indicated by the arrow 28, thereby disengaging the first input stage El and moving the second shift rail 15 into the neutral position N thereof (see FIG. 20e). The second friction clutch K2 is then engaged if necessary.

### Reference Characters

1 group transmission
1′ group transmission
1* group transmission
2 drive shaft
3 clutch drum
4 first input shaft
5 second input shaft
6a, 6b countershaft
7 main shaft
8 sun gear
9 planet carrier
10 ring gear
11 housing component
12 output shaft
13 shifting device
13′ shifting device
13* shifting device
14 first shift rail
15 second shift rail
16 selector shaft
17a, 17b engagement opening of the first shift rail
18a, 18b engagement opening of the second shift rail
19 first selector finger
20 second selector finger
21 radial plane, reference plane
22 axial direction arrow, axial displacement
23 axial direction arrow, axial displacement
24 axial direction arrow, axial displacement
25 rotational direction arrow, rotation
26 axial displacement
27 rotation
28 axial displacement
29 rotation
30 axial displacement
a selector angle distance
b shift travel distance
BG range change group
E1 first input stage, shift position
E1* irregular shift position of El
E2 second input stage, shift position
E3 third input stage, shift position
E4 fourth input stage, shift position
HG main gearing
H1 first forward main step
H2 second forward main step
K1 first friction clutch
K2 second friction clutch
L shift position of the clutch SB
N neutral position, shift position
R reverse main step
S shift position of the clutch SB
SB clutch
S1 first shifting group
S1* first shifting group
S2 second shifting group
S2′ second shifting group
S2* second shifting group
S3 third shifting group
S4 fourth shifting group
VG splitter group
VG′ splitter group
VG* splitter group

1-10. (canceled)

11. An automated group transmission comprising:
a shifting device (13, 13′, 13*),
the group transmission comprising a main gearing (HG) and a splitter group (VG, VG′, VG*) upstream of the main gearing (HG), and at least one common countershaft (6a, 6b),
the splitter group (VG, VG′, VG*) being a double clutch transmission having two coaxially disposed input shafts (4, 5), each of which are connectable, on an input side via an allocated friction clutch (K1, K2), to a drive shaft (2) of a drive motor and, on an output side via at least one shiftable input stage (E1, E2; E3, E4), to the countershaft (6a, 6b),
each of the input shafts (4, 5) being allocated a shift rail (14, 15), each of which is disposed axially parallel and being axially displaceable,
each of the shift rails (14, 15) having an adjustment connection to a selector sleeve of an allocated shifting group (S1, S2, S2′, S1*, S2*) via a shift fork and having at least one engagement opening (17a, 17b, 18a, 18b),
a selector shaft (16) being disposed axially parallel to the shift rails (14, 15) and comprises at least one selector finger (19, 20) for engaging in the engagement openings (17a, 17b, 18a, 18b) of the shift rails (14, 15), the selector shaft (16) being rotatable (25) about a longitudinal axis thereof, via a selection positioner, and being axially displaceable (24) via a shifting actuator,
the splitter group (VG) having two shiftable input stages (E1, E3; E2, E4) per input shaft (4, 5), and each of the shift rails (14, 15) being equipped with two engagement openings (17a, 17b; 18a, 18b), which are approximately as wide as the allocated selector finger (19, 20) of the selector shaft (16) and being separated from one another axially by twice a shift travel distance (2*b) of the shifting groups (S1, S2) and being symmetrically disposed with respect to a neutral position (N, 21) of the particular shift rail (14, 15), and
the selector shaft (16) being rotatable (25) between two selected positions that are separated by a selector angle distance (a), each of the two selected positions corresponds to an engagement of the allocated selector finger (19, 20) into an engagement opening (17a, 17b; 18a, 18b) of one of the shift rails (14, 15), and the selector shaft (16) being axially displacable (24) to five shift positions, which are separated from each other axially by a shift travel separation (b) of the shifting groups (S1, S2) and the five shift positions are symmetrically disposed with respect to the neutral position (21) of the selector shaft (16).

12. An automated group transmission comprising:
a shifting device (13, 13′, 13*),
the group transmission comprising a main gearing (HG) and a splitter group (VG, VG′, VG*) located upstream from the main gearing (HG) and having at least one common countershaft (6a, 6b),
the splitter group (VG, VG′, VG*) being a double clutch transmission having two coaxially disposed input shafts (4, 5), each of the input shafts (4, 5) being connectable, on an input side via an allocated friction clutch (K1, K2), to a drive shaft (2) of a drive motor and, on an output side via at least one shiftable input stage (E1, E2; E3, E4), to the countershaft (6a, 6b),
each of the input shafts (4, 5) being allocated one of a first and a second shift rail (14, 15) which are disposed axially parallel and axially displaceable, each of the first and the second shift rails (14, 15) having an adjustment connection to the selector sleeve of an allocated shifting group (S1, S2, S2′, S1*, S2*) via a shift fork and having at least one engagement opening (17a, 17b, 18a, 18b),
a selector shaft (16) being disposed axially parallel to the first and the second shift rails (14, 15), the selector shaft (16) comprises at least one selector finger (19, 20) for engaging in engagement openings (17a, 17b, 18a, 18b) of the first and the second shift rails (14, 15) and the selector shaft (16) being rotatable (25) about a longitudinal axis thereof via a selection positioner, and being axially displaceable (24) via a shifting actuator,
the splitter group (VG′) having two input stages (E1, E3) that are allocated to one of the input shafts (4) and only one other input stage (E2) being allocated to the other input shaft (5), and the first shift rail (14) allocated to a two-stage shifting group (S1) being equipped with only one engagement opening (17a), which is approximately as wide as the allocated selector finger (19) of the selector shaft (16) and being disposed axially in a shift travel separation (b) of the allocated shifting group (S1) in a shifting direction of the other input stage (E2) of the other shifting group (S2′) from a neutral position (N, 21) of the first shift rail (14), the second shift rail (15) allocated to the single-stage shifting group (S2′) being equipped with two engagement openings (18a, 18b), which are approximately as wide as the allocated selector finger (20) of the selector shaft (16) and the two engagement openings (18a, 18b) being separated from one another axially by twice the shift travel separation (2*b) of the allocated shifting group (S2′) and being symmetrically disposed with respect to a neutral position (N, 21) of the applicable shift rail (15), and
the selector shaft (16) being rotatable (25) between two selected positions that are separated by a selector angle distance (a), each of the two selected positions corresponding to an engagement of the allocated selector finger (19, 20) into an engagement opening (17a, 18a, 18b) of one of the first and the second shift rails (14, 15), and the selector shaft (16) being axially displacable to first, second, third and fourth shift positions, which are separated from each other axially in the shift travel separation (b) of the shifting groups (S1, S2′), the first shift position lying in a neutral position (21) of the selector shaft (16), the second and the third shift positions lying axially with respect to the neutral position (21) of the selector shaft (16) on a side of a common shifting direction (28) of both shifting groups (S1, S2′), and the fourth shift position lying axially with respect to the neutral position (21) of the selector shaft (16) on a side of the shifting direction that is present only in one shifting group (S1).

13. An automated group transmission comprising:
a shifting device (13, 13′, 13*),
the group transmission comprising a main gearing (HG) and a splitter group (VG, VG′, VG*) located upstream from the a main gearing (HG) and having at least one common countershaft (6a, 6b), the splitter group (VG, VG′, VG*) being a double clutch transmission having two coaxially disposed input shafts (4, 5), each of the input shafts (4, 5) is connectable, on an input side via an allocated friction clutch (K1, K2), to a drive shaft (2) of a drive motor and on an output side, via at least one shiftable input stage (E1, E2; E3, E4), to the countershaft (6a, 6b),
each of the input shafts (4, 5) being allocated one of a first and a second shift rail (14, 15) which are disposed axially parallel and axially displaceable, and each of the first and the second shift rails (14, 15) having an adjustment connection to a selector sleeve of an allocated shifting group (S1, S2, S2′, S1*, S2*) via a shift fork and having at least one engagement opening (17a, 17b, 18a, 18b),
a selector shaft (16) being disposed axially parallel to the first and the second shift rails (14, 15) and comprises at least one selector finger (19, 20) for engaging in the engagement openings (17a, 17b, 18a, 18b) of the first and the second shift rails (14, 15), and the selector shaft (16) being rotatable (25) about a longitudinal axis thereof via a selection positioner, and being axially displaceable (24) via a shifting actuator,
the splitter group (VG*) having two input stages (E1, E3) allocated to one of the input shafts (5) and only one input stage (E2) allocated to the other input shaft (4), an axially centrally disposed input stage (E1) of the two input stages being a start-up input stage and being connectable also to the other input shaft (4) in an irregular manner, the second shift rail (15), being allocated to the regularly two-stage shifting group (S2*), is equipped with only one engagement opening (18a), which is approximately as wide as the allocated selector finger (20) of the selector shaft (16) and being disposed axially in a shift travel separation (b) of the allocated shifting group (S2*) in a shifting direction of the regular input stage (E2) of the other shifting group (S1*) with respect to the neutral position (N, 21) of the second shift rail (15), the first shift rail (14), which is allocated to the irregularly two-stage shifting group (S1*), being equipped with two engagement openings (17a, 17b), which are approximately as wide as the allocated selector finger (19) of the selector shaft (16) and being separated from one another axially by twice the shift travel separation (2*b) of the shifting group (S1*) and being symmetrically disposed with respect to the neutral position (N, 21) of the first shift rail (14), and the selector shaft (16) being rotatable to two selected positions which are separated by a selector angle distance (a), each of the two selected positions corresponding to an engagement of the allocated selector finger (19, 20) into an engagement opening (17a, 17b, 18a) of one of the first and the second shift rails (14, 15), and being rotatable and axially displacable (25) in first, second, third and fourth shift positions, the first, the second, the third and the fourth shift positions being separated from one another axially by the shift travel separation (b) of the shifting groups (S1*, S2*), and
the first shift position lying in a neutral position (21) of the selector shaft (16), the second and the third shift positions lying axially with respect to the neutral position (21) of the selector shaft (16) on a side of a common regular shifting direction (26) of both of the shifting groups (S1*, S2*), and the fourth shift position lying axially with respect to the neutral position (21) of the selector shaft (16) on a side of a shifting direction (28) that is present irregularly in the one shifting group (S1*).

14. The automated group transmission according to claim 11, wherein a switching device is provided, a common selection actuator of the main gearing (HG) and the splitter group (VG, VG′, VG*) can be shifted by the switching device between an adjustment connection to a selector shaft of the main gearing (HG) and the selector shaft (16) of the splitter group (VG, VG′, VG*).

15. A method for the shifting control of an automated group transmission (1, 1′, 1*) comprising a shifting device (13, 13′, 13*), the group transmission having a main gearing (HG) and a splitter group (VG, VG′, VG*) upstream of the main gearing (HG), and at least one common countershaft (6a, 6b), the splitter group (VG, VG′, VG*) being a double clutch transmission having two coaxially disposed input shafts (4, 5), each of which are connectable on an input side, via an allocated friction clutch (K1, K2), to a drive shaft (2) of a drive motor and on an output side, via at least one shiftable input stage (E1, E2; E3, E4), to the countershaft (6a, 6b), each of the input shafts (4, 5) is allocated a shift rail (14, 15), each of which is disposed axially parallel and is axially displaceable, and each of the shift rails (14, 15) having an adjustment connection to a selector sleeve of an allocated shifting group (S1, S2, S2′, S1*, S2*) via a shift fork and having at least one engagement opening (17a, 17b, 18a, 18b), and a selector shaft (16) is disposed axially parallel to the shift rails (14, 15) and comprises at least one selector finger (19, 20) for engaging in the engagement openings (17a, 17b, 18a, 18b) of the shift rails (14, 15), the selector shaft (16) being rotatable (25) about a longitudinal axis thereof via a selection positioner, and being axially displaceable (24) via a shifting actuator, the splitter group (VG) has two shiftable input stages (E1, E3; E2, E4) per input shaft (4, 5), and each of the shift rails (14, 15) is equipped with two engagement openings (17a, 17b; 18a, 18b), which are approximately as wide as the allocated selector finger (19, 20) of the selector shaft (16) and are separated from each other axially by twice a shift travel distance (2*b) of the shifting groups (S1, S2) and are symmetrically disposed with respect to a neutral position (N, 21) of the particular shift rail (14, 15), and the selector shaft (16) is rotatable (25) between two selected positions that are separated by a selector angle distance (a), each of the two selected positions corresponding to an engagement of the allocated selector finger (19, 20) into an engagement opening (17a, 17b; 18a, 18b) of one of the shift rails (14, 15), and the selector shaft (16) is axially displacable (24) to five shift positions, which are separated from each other axially by a shift travel separation (b) of the shifting groups (S1, S2) and the five shift positions are symmetrically disposed with respect to the neutral position (21) of the selector shaft (16), a change of the load-transmitting input stage (E1, E2, E3, E4) within the splitter group (VG, VG′, VG*) is always executed as a power shift, the method comprising the steps of:
changing from one power input stage (E1) allocated to the one input shaft (4) to a target input stage (E2) allocated to the other input shaft (5), starting from an adjustment connection of the selector shaft (16) to the shift rail (15), located in the neutral position thereof (N, 21), of the non-load-transmitting input shaft (5), by initially axially displacing (26) the shift rail (15) along the shift travel distance (b) into the shift position of the target input stage (E2);
disengaging, with temporal overlap, the friction clutch (K1) allocated to the power input stage (E1) and engaging the friction clutch (K2) allocated to the target input stage (E2);
disengaging the adjustment connection of the selector shaft (16) to the input shaft (15), which is now load-transmitting, via rotation (27) of the selector shaft (16) by the selector angle distance (a);
establishing an adjustment connection to the shift rail (14) of the previously load-transmitting input shaft (4); and
axially displacing (28) the shift rail (14) by a shift travel distance (b) into the neutral (N, 21) position thereof.

16. The method according to claim 15, further comprising the step of initially carrying out a shift into an intermediate input stage (E2) when changing from a power input stage (E3) allocated to the one input shaft (4) to the target input stage (El) allocated to the same input shaft (4), the intermediate input stage (E2) is allocated to the other input shaft (5) and has a middle gear ratio, and then carrying out a shift into the target input stage (E1), in which the applicable shift rail (14) is axially displaced (30) by twice the shift travel distance (2*b) when shifting the allocated shifting group (S1) from the power input stage (E3) to the target input stage (E1).

17. The method according to claim 15, further comprising the step of first disengaging the friction clutch (K2) allocated to the non-load-transmitting input shaft (5), in a passively engageable embodiment of the friction clutches (K1, K2), and subsequently engaging the friction clutch (K1) allocated to the previously load-transmitting input shaft (4).

18. The method according to claim 15, further comprising the step of shifting the shifting device at a beginning of a start-up procedure, with both of the friction clutches (K1, K2) being disengaged, a start-up input stage (E1) being engaged in the shifting group (S2*) of the one shift rail (15) and an adjustment connection of the selector shaft (16) to the other shift rail (14), which is located in the neutral position (N, 21) thereof, being formed, axially displacing the other shift rail (14) by a shift travel distance (b) into the shift position of the irregularly engageable start-up input stage (E1), such that both friction clutches (K1, K2) are at least partially engaged simultaneously.

19. The method according to claim 18, further comprising the steps of initially disengaging, as the start-up procedure progresses, the friction clutch (K1) allocated to the other shift rail (14) of the irregularly engaged start-up input stage (E1) and subsequently axially displacing the other shift rail (14) by twice the shift travel separation (2*b) into the shift position of the higher input stage (E2) of the same shifting group (S1*), whereupon, with temporal overlap, disengaging the friction clutch (K2) allocated to the start-up input stage (E1) and engaging the friction clutch (K1) allocated to the higher input stage (E2), then disengaging, via rotation (29) of the selector shaft (16) by the selector angle distance (a), the adjustment connection of the selector shaft (16) to the shift rail (14) of the input shaft (4), which is now load-transmitting, and establishing an adjustment connection with the shift rail (15) of the previously load-transmitting input shaft (5), and finally axially displacing the shift rail (15) by the shift travel distance (b) into the neutral position (N, 21) thereof.
